(19) United States
(12) Patent Application Publication
(10) Pub. No.: US 2026/0260542 A1
(43) Pub. Date: Sep. 3, 2026

(54) DYNAMIC PROGRESSIVE AWARD CONFIGURATIONS

(71) Applicant: IGT, Las Vegas, NV (US)

(72) Inventors: Dwayne R. Nelson, Las Vegas, NV (US); Kevin Higgins, Reno, NV (US)

(21) Appl. No.: 19/068,819

(22) Filed: Mar. 3, 2025

(51) Int. Cl. G07F 17/32

(52) U.S. Cl. CPC G07F 17/3258; G07F 17/3227

(57) ABSTRACT

Systems and methods that maintain a progressive award associated with a first gaming device. Responsive to an occurrence of a progressive award modification event, the systems and methods modify a value of the progressive award. Responsive to the modified value of the progressive award being associated with a progressive award reassociation event, the systems and methods identify a second gaming device, and modify any association between the progressive award and the identified second gaming device.

### BACKGROUND

In various embodiments, responsive to an amount of a progressive award being associated with an occurrence of a progressive award reassociation event, the systems and methods of the present disclosure modify which gaming devices are associated with the progressive award.

Gaming machines may provide players awards in primary games. Gaming machines generally require the player to place or make a wager to activate the primary game. The award may be based on the player obtaining a winning symbol or symbol combination and on the amount of the wager.

### BRIEF DESCRIPTION OF THE FIGURES

FIG. 1 is a flow chart of an example process for operating a system that associates one or more gaming devices with a progressive award upon an occurrence of a progressive award reassociation event.

FIGS. 2A and 2B are example configurations of different gaming establishment components operating to modify how they operate responsive to an occurrence of a progressive award reassociation event.

FIG. 3 is a flow chart of an example process for operating a system that disassociates one or more gaming devices from a progressive award upon an occurrence of a progressive award reassociation event.

FIG. 4 is a schematic block diagram of one embodiment of an electronic configuration of an example system of the present disclosure.

FIGS. 5A and 5B are perspective views of example alternative embodiments of an electronic gaming machine of the present disclosure.

FIG. 5C is a front view of an example personal gaming device of the present disclosure.

### DETAILED DESCRIPTION

In various embodiments, responsive to an amount of a progressive award being associated with an occurrence of a progressive award reassociation event, the systems and methods of the present disclosure modify which gaming devices are associated with the progressive award.

In certain embodiments, the system maintains a progressive award with one or more attributes that periodically change based on different activities or events occurring. As one or more attributes of the progressive award change, the system modifies which gaming devices are associated with the progressive award and thus changes which gaming devices may win the progressive award. In operation of such embodiments, following an occurrence of a progressive award reassociation event, one or more components of the system, such as a configuration host, modify one or more gaming devices by altering which software packages are/are not installed on such gaming devices (or alternatively altering which installed software packages are/are not executable by the gaming device) to enable or disable a progressive award from being associated with that progressive award. In certain such embodiments, one or more components of the system modify one or more gaming devices by adding (or removing) a game software package associated with a game that enables an opportunity to win the progressive award. As such, responsive to occurrences of different activities or events which cause a modification of one or more attributes of a progressive award, the system correspondingly modifies available interactions between zero, one or more of such gaming devices and one or more components that maintain the progressive award and thus modifies how such gaming devices operate.

In certain instances, as the progressive award grows in value (i.e., as the value attribute of the progressive award changes), the system periodically adds gaming devices to being associated with the progressive award by modifying how such gaming devices operate relative to one or more components that maintain the progressive award. Such a configuration provides that as additional users at gaming devices not associated with the progressive award want an opportunity to win the progressive award, the system dynamically reconfigures such gaming devices to being associated with the progressive award and thus enables the users of such gaming devices the opportunity to potentially win the incremented amount of the progressive award.

In certain other instances, as the progressive award is reduced in value (i.e., as the value attribute of the progressive award changes), such as following a progressive award reset event, the system removes gaming devices from being associated with the progressive award by modifying how such gaming devices operate relative to one or more components that maintain the progressive award. In these embodiments, with a reduced base of users at gaming devices currently associated with the progressive award, the system dynamically reconfigures such gaming devices to not being associated with the progressive award and thus the system does not allocate relatively low valued progressive awards to more gaming devices than necessary. Additionally, since the association of a progressive award with a gaming device is associated with certain fees paid by the gaming establishment operator, such a configuration enables the gaming device operator to avoid having to incur such fees when interest in the progressive award is relatively low based on the relatively low value of the progressive award.

In certain embodiments, in addition to modifying the operation of one or more gaming devices (and the corresponding fees structure for gaming device operators) based on relative demand for a progressive award quantified by a relative value of the progressive award, the system modifies the operation of one or more gaming establishment controllers (e.g., one or more gaming device bank controllers and/or one or more sign controllers) to account for the operational modification of such gaming devices. In these embodiments in which the gaming devices include electronic gaming machines situated on a gaming establishment floor, as the operational parameters of one or more electronic gaming machines change, the system changes the operational parameters of one or more gaming establishment controllers such that one or more output devices, such as display devices, output information reflective of the current progressive award configuration. In certain instances, if a progressive award becomes associated with an electronic gaming machine (“EGM”), the system communicates data, such as one or more graphic packages, to an EGM bank controller (and/or a sign controller) associated with that EGM to enable the EGM bank controller (and/or the sign controller) to control one or more display devices to display the progressive award and/or graphics of a game added to the EGM to enable an opportunity to win the progressive award. Conversely, if a progressive award becomes disassociated from an EGM, the system communicates data to an EGM bank controller (and/or a sign controller) associated with that EGM to disable the EGM bank controller (and/or the sign controller) from causing any display devices to display the progressive award and/or graphics of a game removed from the EGM. Such a configuration provides that as the floor of a gaming establishment changes with the reconfiguration of EGMs based on the changing attributes of a progressive award, the system informs one or more secondary controllers (e.g., an EGM bank controller and a sign controller) to keep the floor up-to-date with the latest configurations.

In certain embodiments, in addition to modifying the operation of one or more gaming devices (and the corresponding fees due by gaming device operators) based on relative demand for a progressive award quantified by a relative value of the progressive award, the system modifies how one or more online casinos operate by modifying certain content displayed. In certain such embodiments in which the gaming device includes a personal gaming device accessing an online casino via a webpage or an application, responsive to a progressive award reassociation event, the system alters one or more aspects of a lobby of the online casino to emphasize (or deemphasize) certain progressive awards which may be available to be won from one or more games launchable from the lobby. For example, the system utilizes the current value of a progressive award to determine which content to display in a marketing widget associated with the lobby of an online casino. Such a configuration offers an operational advancement as the lobby of an online casino is changed from a static interface (which simply shows games available to be launched) to a dynamic interface in which the current attributes of a progressive award are available to be accessed directly from the lobby without having to launch any specific games first.

While certain embodiments described below are directed to modifying a configuration of a gaming device, a gaming establishment controller and/or an online casino interface based on one or more parameters of a progressive award (e.g., based on a current value of a progressive award), it should be appreciated that such embodiments may additionally or alternatively be employed in association with modifying a configuration of a gaming device, a gaming establishment controller and/or an online casino interface based on one or more parameters of a non-progressive award, such as static award funded from a paytable. Moreover, while certain embodiments described below are directed to modifying a configuration of an electronic gaming machine (such as, but not limited to, a slot machine, a video poker machine, a video lottery terminal, a terminal associated with an electronic table game, a terminal associated with a live table game, a video keno machine, a video bingo machine and/or a sports betting terminal that offers sports betting opportunities), a gaming establishment controller and/or an online casino interface based on one or more parameters of a progressive award, it should be appreciated that such embodiments may additionally or alternatively be employed in association with any suitable gaming device, such as one or more personal gaming devices that enable online wagering and/or online social games.

In various embodiments, the system maintains a progressive award. In certain embodiments, prior to any EGMs being reconfigured to be associated with the progressive award, the progressive award is a stand-alone progressive award associated with a single EGM. In certain embodiments, prior to any EGMs being reconfigured to be associated with the progressive award, the progressive award is a stand-alone progressive award associated with a plurality of EGMs. In certain embodiments, the progressive award includes a plurality of levels such that, prior to any EGMs being reconfigured to be associated with any of the levels of the progressive award, the progressive award is a multi-level progressive (“MLP”) award associated with a single EGM. In certain embodiments, prior to any EGMs being reconfigured to be associated with any of the levels of the progressive award, the MLP award is associated with a plurality of EGMs. In different embodiments in which a progressive award is associated with a plurality of EGMs, the EGMs may be in (or otherwise associated with) a single gaming establishment (such that the progressive award may be considered a local area progressive (“LAP”)) or the EGMs may be in (or otherwise associated with) two or more different gaming establishments (such that the progressive award may be considered a wide area progressive (“WAP”)).

In certain embodiments, the progressive award is associated with a default configuration of one or more EGMs that the progressive award will remain associated with before and/or after any progressive award reassociation events. Put differently, while one or more progressive award configurations may result in the progressive award being associated with a modified configuration of which EGMs are associated with the progressive award, prior to any EGMs being reconfigured to be associated with a progressive award or after each of any EGMs are reconfigured to no longer be associated with the progressive award, the system reverts, by default, to one or more EGMs being associated with the progressive award.

It should be appreciated that while certain prior systems included one or more EGMs that were, by default, associated with a progressive award, such prior systems lacked any modified configurations of which EGMs were associated with the progressive award. Such prior systems resulted in certain technical problems when the progressive award grew in value because the default configuration of which EGMs could be associated with the progressive was static (thus preventing users at other EGMs from the opportunity to win the progressive award). For example, a gaming establishment employing such a prior system may have four EGMs connected to a progressive controller maintaining a progressive award with a reset value of $20,000,000. In this example, as the progressive award increases to more than $30,000,000, more users want to engage EGMs for a chance to win the progressive award (i.e., more EGMs are needed to satisfy the increased demand) but the gaming establishment operator was limited by physically adding another EGM to the gaming establishment floor to satisfy that demand. To add another EGM and associate that EGM with a progressive controller which maintains the progressive award, the gaming establishment operator must cause the additional EGM to communicate with the progressive controller which is a costly operation and is further limited by physical space and the capacity of the hardware and/or software of the progressive controller which, in certain instances, was only operable to host a set number of EGMs. Moreover, even if the gaming establishment operator went through with the tasks to physically add another EGM to satisfy demand for an elevated progressive award, once the progressive award was won and the amount of the progressive award was reduced back to a relatively lower reset value, demand fell and the gaming establishment operator would want to physically remove that EGM from the gaming establishment floor (i.e., another relatively costly operation) to account for the reduced demand. Accordingly, unlike such prior systems and as described in more detail below, the system of the present disclosure enables for the addition and removal of EGMs from being associated with a progressive award without the need to physically add or remove any EGMs from the gaming establishment floor.

It should be further appreciated that since certain progressive awards are associated with certain fees (e.g., a daily fee of $40 per EGM associated with the progressive award or a percentage of coin-in of the EGM associated with the progressive award), the above-described problem with prior systems is only compounded as demand fluctuated based on the relative value of the progressive award. That is, when a progressive award has a relatively high value, the demand for opportunities to win that progressive award justifies the associated fees. On the other hand, when a progressive award has a relatively low value, the demand for opportunities to win that progressive award does not justify the associated fees. However, the static association between fee owing EGMs and the progressive award of such prior system prevented any dynamic assessment of fees. Accordingly, unlike such prior systems and as described in more detail below, the system of the present disclosure enables for the addition, removal or adjustment of certain fees in association with the progressive award as demand changes (i.e., gaming establishment operators realize the benefits associated with higher valued progressive awards while avoiding the fee-based negatives associated with lower valued progressive awards).

In certain embodiments, the progressive award is not associated with any default configuration of any EGMs that the progressive award will remain associated with before and/or after any progressive award reassociation events. In these embodiments, the progressive award maintains a dynamic configuration as different EGMs are added to or removed from being associated with the progressive award at different points in time.

In certain embodiments, each progressive award is associated with a reset value utilized following a progressive award triggering event associated with that progressive award. In certain embodiments wherein the system maintains a plurality of progressive awards, each of the progressive awards has the same progressive award reset value. In certain embodiments wherein the system maintains a plurality of progressive awards, two or more of the progressive awards have different progressive award reset values.

In certain embodiments, each progressive award is also associated with a progressive award contribution rate that represents, in certain instances, the portion of each wager placed (or the portion of each designated wager, such as a maximum wager, placed) that is allocated to that progressive award. In certain embodiments wherein the system maintains a plurality of progressive awards, each of the progressive awards has the same progressive award contribution rate. In certain embodiments wherein the system maintains a plurality of progressive awards, two or more of the progressive awards have different progressive award contribution rates.

In certain embodiments, one or more progressive awards are each associated with a range of values, wherein the low end of the range of values represents the reset value of that progressive award and the high end of the range of values represents the maximum amount which that progressive award may reach. In these embodiments, the amount which the progressive award may be incremented to is capped or limited by the highest value in the value range associated with such progressive award. In these embodiments, the system displays the current value of the progressive award and/or the maximum amount which the progressive award may reach. In other embodiments, one or more progressive awards are each not associated with any range of values. In this embodiment, that progressive award continues to be incremented until a progressive award triggering event occurs.

In addition to maintaining one or more progressive awards, the system determines if a progressive award modification event has occurred. In certain embodiments, the progressive award modification event includes a progressive award increment event. In one such embodiment, the progressive award increment event occurs based on (or as a result of) a wager being placed on a play of a game at an EGM currently associated with the progressive award. In another such embodiment, the progressive award increment event additionally or alternatively occurs based on (or as a result of) a side wager being placed at an EGM currently associated with the progressive award. In another such embodiment, the progressive award increment event additionally or alternatively occurs based on (or as a result of) one or more displayed events occurring in association with one or more plays of one or more games of an EGM currently associated with the progressive award. In another such embodiment, the progressive award increment event occurs independent of any displayed events associated with any plays of any games of any EGM currently associated with the progressive award. For example, a gaming establishment may periodically cause an occurrence of a progressive award increment event with funds drawn from the gaming establishment marketing department.

If the system determines that a progressive award increment event occurred, the system increases the amount of the progressive award. In certain embodiments wherein the progressive award increment event occurs based on a placed wager, the increase of a maintained award is funded by a portion of the wager placed (e.g., a progressive award contribution rate of 1% of the amount of the wager placed is allocated to growing the progressive award). In certain other embodiments wherein the progressive award increment event occurs based on a placed side wager, the increase of a maintained award is funded by part or all of the side wager placed (e.g., a progressive award contribution rate of 50% of the amount of the side wager placed is allocated to growing the progressive award). In certain other embodiments, the system utilizes an amount provided by one or more marketing and/or advertising departments, such as a gaming establishment marketing department, to fund part or all of the increase of a maintained award upon an occurrence of a progressive award increment event.

In addition to increasing the displayed value of a progressive award (if the progressive award increment event occurs) or maintaining the current displayed value of the progressive award (if no progressive award increment event occurs), the system determines if a progressive award reassociation event has occurred. In certain embodiments, the progressive award reassociation event occurs based on one or more parameters of the progressive award, such as based on a current value of a progressive award relative to one or more threshold values. In certain embodiments, the progressive award reassociation event occurs based on one or more parameters of the progressive award and one or more reconfiguration factors, such as the current quantity of EGMs associated with the progressive award (in certain instances relative to any limits), and/or demand (current and/or anticipated) for additional EGMs to be associated with the progressive award.

In certain embodiments in which the progressive award reassociation event occurs based on a value of the progressive award, if a value of the progressive award exceeds an incremented threshold value, the system dynamically associates one or more EGMs with the progressive award. In certain such embodiments, the system employs a single incremented threshold value which, when reached, causes the system to associate one or more additional EGMs with the progressive award. In certain other embodiments, the system employs a plurality of incremented threshold values which, when each are reached, cause the system to associate one or more additional EGMs with the progressive award. In operation of such embodiments, the system monitors the value of the progressive award and determines, based on at least the monitored value of the progressive award relative to one or more incremented threshold values, whether to add any EGMs to being associated with the progressive award. For example, a configuration host (i.e., a component of the system) tracks the current value of a progressive award having a reset value of $20,000,000 and causes a first progressive award reassociation event to occur and one or more EGMs to be reconfigured to be associated with the progressive award when the progressive award reaches $30,000,000. In this example, as the progressive award continues to grow in value, the configuration host causes subsequent progressive award reassociation events to occur and more EGMs to be reconfigured to be associated with the progressive award for every $5,000,000 of incremental growth above $30,000,000. In another example, a configuration host tracks the current value of a progressive award having a reset value of $20,000,000 and causes a first progressive award reassociation event to occur and one or more EGMs to be reconfigured to be associated with the progressive award when the progressive award reaches $30,000,000. In this example, while the progressive award continues to grow in value, the configuration host then causes subsequent progressive award reassociation events to occur and more EGMs to be reconfigured to be associated with the progressive award at a periodic intervals (e.g., daily) until the progressive award is reset to the $20,000,000 reset value. As illustrated by these examples, as the progressive award grows in value, the system adds more EGMs to being associated with the progressive award (and thus offers more users the opportunity to win the progressive award).

In certain embodiments, in addition to accounting for the current value of the progressive award in determining if a progressive award reassociation event occurs, the system accounts for the current state of any EGMs already associated with the progressive award. In these embodiments, if a value of the progressive award exceeds an incremented threshold value, the system determines if any EGMs already associated with the progressive award are being actively played (e.g., are credits on the credit meter of the EGM, is a user logged into a player tracking system from the EGM and/or is gaming session currently occurring on the EGM). If at least a threshold quantity of such EGMs are not being actively played, the system determines that no progressive award reassociation event occurs because the demand for opportunities to engage EGMs associated with the progressive award is currently met. On the other hand, if at least a threshold quantity of such EGMs are being actively played, the system determines that a progressive award reassociation event occurs (because the demand for opportunities to engage EGMs associated with the progressive award is not being met) and associates one or more additional EGMs with the progressive award. In these embodiments, as the progressive award grows in value and other conditions are satisfied, the system adds more EGMs to being associated with the progressive award (and thus offers more users the opportunity to win the progressive award).

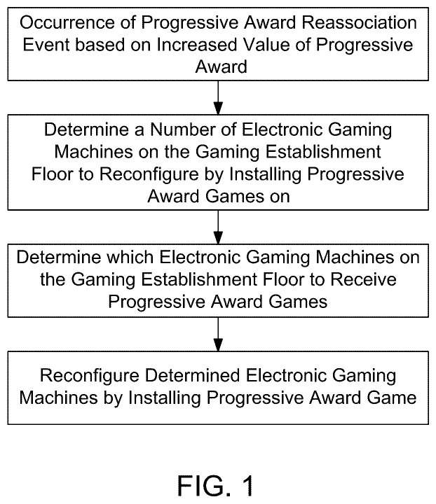

In certain embodiments, after determining that a progressive award reassociation event has occurred and one or more EGMs will be added to being associated with the progressive award, the system reconfigures the relationship between the progressive award and one or more EGMs by determining a quantity of additional EGMs to associate with the progressive award. For example, as seen in FIG. 1, following an occurrence of a progressive award reassociation event, the system determines a number of EGMs on the gaming establishment floor to reconfigure by installing progressive award games (i.e., games associated with opportunities to win the progressive award) on. In certain embodiments in which one or more EGMs are associated with a progressive award if a value of the progressive award exceeds an incremented threshold value, the system employs the value of the progressive award to determine the quantity of additional EGMs to associate. In certain such embodiments in which the system employs a plurality of incremented threshold values, the system adds a set quantity of EGMs to being associated with the progressive award when each incremented threshold value is reached. For example, each $1,000,000 of growth of a progressive award results in the system adding a static quantity of EGMs to being associated with the progressive award.

In certain embodiments in which one or more EGMs are associated with a progressive award if a value of the progressive award exceeds an incremented threshold value, the system additionally or alternatively dynamically determines the quantity of additional EGMs to associate based on demand feedback. In these embodiments, once the system determines that a progressive award reassociation event occurs, the system incrementally associates additional EGMs to being associated with the progressive award until the system determines that demand stabilizes. For example, following a determination to associate a quantity of additional EGMs with a progressive award, the system associates one additional EGM with the progressive award at a time until the system determines that play of the additional EGMs stops increasing (i.e., supply meets demand).

In certain other embodiments in which one or more EGMs are associated with a progressive award if a value of the progressive award exceeds an incremented threshold value, the system dynamically determines the quantity of additional EGMs to associate with the progressive award based on certain gaming establishment floor metrics. In these embodiments, once the system determines that a progressive award reassociation event occurs, the system analyzes certain gaming establishment floor metrics (e.g., the total size of the gaming establishment floor and/or the total play occurring on the gaming establishment floor, anticipated play on the gaming establishment floor) and determines, based on such an analysis, how many additional EGMs to associate with the progressive award.

It should be appreciated that in certain instances, the determination of how many additional EGMs to associate with a progressive award is made against the backdrop of certain limits gaming establishment operators must comply with regarding the configuration of the gaming establishment floor. That is, gaming establishment operators have zero, one or more thresholds or maximums on the number of EGMs that may be associated with a progressive award and the system accounts for these thresholds or maximums in determining the quantity of EGMs to associate with a progressive award when demand rises.

Following the determination of a quantity of EGMs to reconfigure to associate with the progressive award, the system determines which specific EGMs to reconfigure. In these embodiments, the system employs one or more factors to determine which EGM(s) to cause to be associated with the progressive award. For example, as seen in FIG. 1, following a determination of a number of EGMs on the gaming establishment floor to install progressive award games on, the system determines which EGMs on the gaming establishment floor will receive such progressive award games. In certain embodiments, the system determines which EGMs to reconfigure to be associated with the progressive award based on the location of such EGMs relative to one or more EGMs already associated with the progressive award (such that users can see signage already dedicated to displaying information associated with the progressive award, such as the current value of the progressive award). In certain embodiments, the system additionally or alternatively determines which EGMs to reconfigure to be associated with the progressive award based on a compatibility of one or more EGMs with the ability to be modified to offer an opportunity to win the progressive award. That is, the system selects (or otherwise filters out) certain EGMs from being selected based on hardware and/or software incapability issues with a progressive award association. For example, the system selects an EGM configured to play a reel game at a designated denomination to be associated with a progressive award reel game of that denomination. In this example, such filtering out of certain EGMs based on incompatibility issues prevents the progressive award reel game from being offered at a non-reel game EGM. In another example, the selects an EGM associated with a certain EGM manufacturer and filters out EGMs associated with other EGM manufacturers.

In certain embodiments, following the determination of which specific EGMs to reconfigure based on the occurrence of the progressive award reassociation event, the system operates to cause an association of the progressive award with such specific EGMs. For example, as seen in FIG. 1, the system enables the installation and configuration of a progressive award game on the specifically selected target EGMs.

In certain embodiments, if a progressive award reassociation event occurs and a determination to add a specifically identified EGM to being associated with a progressive award also occurs, a configuration host interfaces with that specifically identified EGM to enable the association of that EGM with the progressive award. In such embodiments, the configuration host communicates a new software package to that EGM which, upon receipt of the new software package, installs the new software package. Once installed, the software package enables the EGM to become associated with the progressive award. In certain such embodiments, the new software package to be installed includes a game package to enable the EGM to execute a game associated with a potential opportunity to win the progressive award (i.e., a progressive award game). For example, if there are four EGMs on a gaming establishment floor that have the progressive configuration for a specific game through which the progressive award may be won, when the progressive award increments to a value of $30,000,000 (which results in an occurrence of a progressive award reassociation event associated with adding more EGMs to being associated with the progressive award), the configuration host communicates a new software package including the game package for that specific game to two specifically identified additional EGMs. The two additional EGMs download the packages, configure how they operate based on the downloaded packages and then enable users to play the added specific game for zero, one or more opportunities to win the progressive award.

In certain embodiments, rather than communicating a new software package to install to enable the association of an EGM with a progressive award, the configuration host communicates to that EGM one or more commands to enable or otherwise activate a previously installed (but disabled or otherwise inactive) software package. Once activated, the software package enables the EGM to become associated with the progressive award. In certain such embodiments, the activated software package includes a game package to enable the EGM to execute a game associated with a potential opportunity to win the progressive award (i.e., a progressive award game).

In certain embodiments, the installation or activation of a software package on the EGM to enable the association of an EGM with a progressive award includes the configuration host providing the EGM the network configuration to communicate with an applicable progressive controller, such as providing one or more of the IP address, a URL, one or more communication certificates, and/or one or more passwords to enable the EGM to operate with the progressive controller.

In certain embodiments, when associating a progressive award with an EGM, certain existing configurations of the EGM are disabled. For example, when adding a progressive award game to a target EGM, the existing non-progressive award games on the EGM are disabled such that the EGM may only run the newly installed or activated progressive award game. In certain embodiments, when associating a progressive award with an EGM, certain existing configurations of the EGM remain enabled. For example, when adding a progressive award game to a target EGM, the existing non-progressive award games on the EGM remain enabled and thus may be run on that EGM along with the newly installed or activated progressive award game.

In certain embodiments, if a progressive award reassociation event occurs and a determination to add a specifically identified EGM to being associated with a progressive award also occurs, a configuration host automatically interfaces with that specifically identified EGM to enable the association of that EGM with the progressive award. In certain other embodiments, if a progressive award reassociation event occurs and a determination to add a specifically identified EGM to being associated with a progressive award also occurs, prior to interfacing with that specifically identified EGM to enable the association of that EGM with the progressive award, the configuration host notifies a gaming establishment operator (or other personnel associated with the progressive award) and requests an approval for such a reconfiguration of the EGM. For example, if the system decides to add progressive award games to four EGMs on a gaming establishment floor, the system prompts an operator to approve the request. If the operator approves the request, the system proceeds as described above with reconfiguring the EGM to be associated with the progressive award. On the other hand, if the operator does not approve the request, the system does not associate that EGM with the progressive award (and rather, in certain embodiments, determines alternative reconfiguration requests to present to the operator). In another example, if the system decides to add progressive award games to four EGMs on a gaming establishment floor, the system prompts an operator to approve or adjust the request. In this example, such adjustments pertain to one or more of the number of EGMs being modified, the location of the EGMs being modified and/or the terms of the fees paid or received by the gaming establishment.

Regarding such fees paid or received by the gaming establishment, in certain embodiments, as one or more EGMs are reconfigured to being associated with a progressive award (or alternatively, as one or more EGMs are reconfigured to cease being associated with a progressive award), the system scales the fees associated with the progressive award based on such reconfigurations. In these embodiments, since the quantity of EGMs associated with a progressive award fluctuates based on a value of the progressive award (and thus fluctuates based on demand to engage EGMs associated with the progressive award), the system adjusts the total fees based on the variable quantity of EGMs associated with the progressive award. In certain such embodiments, the system applies a static fee for each interval of time that one or more EGMs are added to be associated with a progressive award in which the fees only accrue while such EGMs are associated with the progressive award. In certain other embodiments, the system applies a variable fee that decreases (or alternatively increases) as more EGMs are associated with the progressive award. In such embodiments, such dynamic pricing enables gaming establishment operators to, in certain instances, receive the benefits of a discount as more and more EGMs are associated with the progressive award. In certain such embodiments, the system applies the static fee and/or variable fee on a per EGM basis. In certain other embodiments, the system applies the static fee and/or variable fee on a bulk basis in which different quantities of EGMs are associated with the same or different fees structures. It should be appreciated that given the transient nature by which certain EGMs are associated with the progressive award, gaming establishment operators will realize a higher return on such fees because fee accrual is relatively limited to when the demand for the progressive award (as evidenced by increased EGM engagement when the value of the progressive award is increased) is elevated. Put differently, the gaming establishment operator benefits via receiving increased revenue during periods of higher gaming activity resulting from the increased value of the progressive award without incurring extra fees when demand subsides after the progressive award is won.

Accordingly, in certain embodiments, responsive to an occurrence of a progressive award modification event, the system modifies a value of the progressive award. In these embodiments, responsive to the modified value of the progressive award being associated with a progressive award reassociation event, the system modifies any association between the progressive award and a quantity of gaming devices, and further modifies a fee associated with the progressive award. In certain such embodiments in which the progressive award modification event includes a progressive award increment event, modifying the value of the progressive award includes increasing the value of the progressive award, and modifying any association between the progressive award and the quantity of gaming devices includes adding the quantity of gaming devices to being associated with the progressive award, modifying the fee associated with the progressive award includes increasing the fee. In certain cases, the increased fee is lower per gaming device for each of the quantity of gaming devices. In certain other embodiments in which the progressive award modification event includes a progressive award decrement event, modifying the value of the progressive award includes decreasing the value of the progressive award, and modifying any association between the progressive award and the quantity of gaming devices includes removing the quantity of gaming devices from being associated with the progressive award, modifying the fee associated with the progressive award includes decreasing the fee. In certain cases, the decreased fee is higher per gaming device for each remaining gaming device associated with the progressive award. In different embodiments, the fee is periodically assessed and/or the fee is assessed on a per gaming device basis.

In certain embodiments, the system thus offers a lower fee structure to gaming establishments that enables the selective association of a progressive award with one or more EGMs of that gaming establishment. In certain embodiments in which the progressive award is associated with EGMs across different gaming establishments (and/or different gaming establishment operators), the system additionally or alternatively enables gaming establishment operators that enable the selective association of a progressive award with one or more EGMs of that gaming establishment to become eligible to win a gaming establishment operator award when a user wins the progressive award at their gaming establishment. In these embodiments, such a gaming establishment operator award is an increasing award that is funded by wagers placed across multiple gaming establishments.

In certain embodiments, if a progressive award reassociation event occurs and a determination to add one or more specifically identified EGMs to being associated with a progressive award also occurs, the system operates with one or more gaming establishment controllers to account for the reassociation of the progressive award with the specifically identified EGMs. That is, in addition to reconfiguring the operation of one or more EGMs based on an occurrence of a progressive award reassociation event, the system configures (or reconfigures) the operation of one or more gaming establishment controllers (which are distinct from, but, in certain instances, operate with such EGMs) based on the occurrence of the progressive award reassociation event. In certain such embodiments, the configuration (or reconfiguration) of the gaming establishment controller includes an installation or activation of a software package on the gaming establishment controller to enable the gaming establishment controller to operate with an applicable progressive controller, such as providing one or more of the IP address, a URL, one or more communication certificates, and/or one or more passwords to enable the gaming establishment controller to operate with the progressive controller.

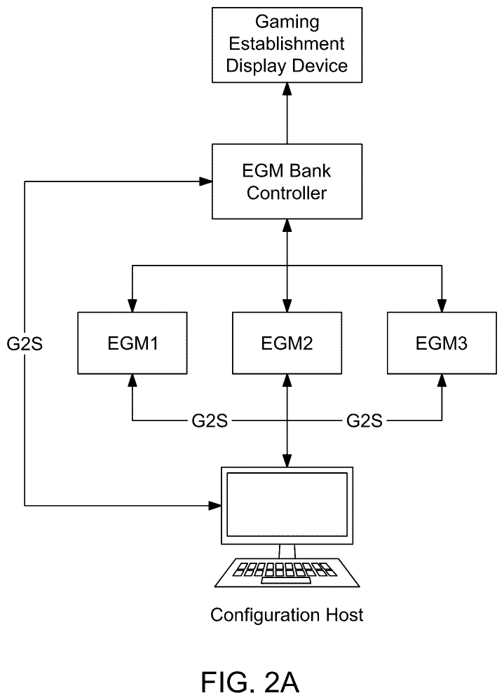

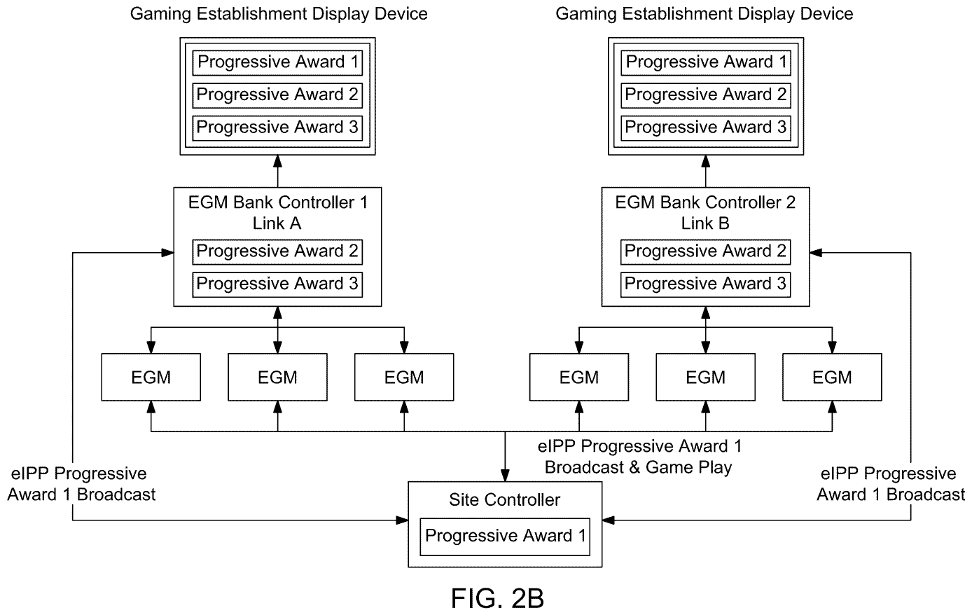

In certain such embodiments, the configuration host operates with a bank controller (e.g., a controller operable with each EGM of a bank of EGMs to coordinate certain operations between the bank of EGMs) to inform the bank controller of the ramifications of the progressive award reassociation event, to modify one or more software packages of the bank controller and/or to enable the bank controller to adjust how it operates accordingly. In these embodiments, as seen in FIG. 2A, following an EGM being associated with a progressive award based on a value of the progressive award, the configuration host adds (and/or modifies) one or more software packages being executed by the bank controller (not shown) to enable the bank controller to account for the association of the progressive award with the EGM, such as enabling the bank controller to control one or more display devices to reflect the association and/or enabling the bank controller to adjust the configuration of one or more other EGMs of the bank based on the association.

In certain such embodiments, the configuration host operates with a site controller (e.g., a controller operable with each EGM of a gaming establishment) to inform the site controller of the ramifications of the progressive award reassociation event, to modify one or more software packages of the site controller and/or to enable the site controller to adjust how it operates accordingly. For example, as seen in FIG. 2B, a site controller is in communication with a plurality of bank controllers such that the occurrence of the progressive award reassociation event causes the site controller to operate with such bank controllers and/or the associated EGMs to effectuate the association (or disassociation) of the progressive award from one or more of such EGMs. In certain such embodiments, following an EGM being associated with a progressive award based on a value of the progressive award, the configuration host adds (and/or modifies) one or more software packages being executed by the site controller to enable the site controller to account for the association of the progressive award with the EGM, such as enabling the site controller to control one or more display devices to reflect the association and/or enabling the site controller to adjust the configuration of one or more other EGMs based on the association.

It should be appreciated that in certain instances, the configuration host operates with the site controller and/or one or more bank controllers based on the progressive award reassociation event. In these instances, when the configuration host adds a bank of EGMs to be dynamically associated with a progressive award (i.e., the configuration host configures all EGMs on a bank to offer a progressive award game), the configuration host configures all EGMs to communicate with the bank controller. The configuration host and/or the site controller then configures the bank controller to operate with one or more bank display devices to display graphics associated with the progressive award game and the value of the dynamically associated progressive award. In addition to operating with the bank controller to account for the progressive award reassociation event, the configuration host and/or the site controller configures, if necessary, each of EGMs on the bank to connect to the site controller.

Accordingly, in certain embodiments, responsive to an occurrence of a progressive award modification event, the system modifies a value of a progressive award. In these embodiments, responsive to the modified value of the progressive award being associated with a progressive award reassociation event, the system modifies any association between the progressive award and an electronic gaming machine and causes a modification of an operation of a gaming establishment controller. In certain such embodiments in which the progressive award modification event includes a progressive award increment event, modifying the value of the progressive award includes increasing the value of the progressive award, and modifying any association between the progressive award and the electronic gaming machine includes associating the progressive award with the electronic gaming machine, causing the modification of the operation of the gaming establishment controller includes enabling the gaming establishment controller to output content associated with the progressive award. In certain cases, the content associated with the progressive award includes at least one of a display of the increased value of the progressive award and graphics of a game associated with an opportunity to win the progressive award. In certain other embodiments in which the progressive award modification event includes a progressive award decrement event, and modifying the value of the progressive award includes decreasing the value of the progressive award, modifying any association between the progressive award and the electronic gaming machine includes disassociating the progressive award from the electronic gaming machine. In certain such cases, causing the modification of the operation of the gaming establishment controller includes disabling the gaming establishment controller from outputting content associated with the progressive award. In other such cases, causing the modification of the operation of the gaming establishment controller includes enabling the gaming establishment controller to output graphics of a game not associated with any opportunity to win the progressive award.

In certain embodiments, the configuration host additionally or alternatively operates with a sign controller (e.g., a controller operable with one or more display devices of a gaming establishment) to inform the sign controller of the ramifications of the progressive award reassociation event, to modify one or more software packages of the sign controller and/or to enable the sign controller to adjust how it operates accordingly. In these embodiments, following an EGM being associated with a progressive award based on a value of the progressive award, the configuration host adds (and/or modifies) one or more software packages being executed by the sign controller to enable the sign controller to account for the association of the progressive award with the EGM, such as enabling the sign controller to control one or more overhead display devices to reflect the association.

In certain embodiments, following the installation or activation of a software package on the EGM to enable the association of an EGM with a progressive award, that EGM is associated with the progressive award such that the progressive award may be won in association with a progressive award triggering event. In certain such embodiments, a progressive award triggering event occurs based on one or more displayed events occurring in association with one or more plays of one or more games. For example, following a game triggering event which enables a user to play a game at an EGM associated with a progressive award, the system utilizes at least part of the play of the game to determine if a progressive award triggering event occurs. In certain embodiments, a progressive award triggering event occurs based on a user achieving a certain outcome, such as obtaining one of more outcomes associated with a specific win category (e.g., winning a royal flush). In certain other embodiments, a progressive award triggering event occurs based on a user (or a group of users) winning a certain amount from a play of a single game or winning a certain amount over a period of time. In certain other embodiments, a progressive award triggering event occurs based on a user (or a group of users) maintaining an active gaming session for a certain amount of time and/or over a certain quantity of games played.

In certain embodiments, a progressive award triggering event occurs independent of any displayed events associated with any plays of any games at an EGM associated with a progressive award. In one embodiment, a progressive award triggering event randomly occurs. In another embodiment, a progressive award triggering event occurs at a randomly selected time.

In certain embodiments, a progressive award triggering event occurs based on a user (or group of users) wagering a certain amount over a period of time. In other embodiments, a progressive award triggering event occurs based on a user (or group of users) participating in one or more offerings available to the user.

In another embodiment, a progressive award triggering event occurs or is otherwise enabled based on a current state of a gaming establishment. In another embodiment, a progressive award triggering event occurs or is otherwise enabled based on a current state of the progressive award. For example, upon the system determining that the current value of a progressive award is within a designated range of a threshold value, the system causes the progressive award triggering event to occur for that progressive award (thereby ensuring that the progressive award does not reach the threshold value).

In another embodiment, a progressive award triggering event occurs as part of a gaming establishment promotion. In certain such embodiments, one or more actions (or inactions) undertaken by the system (or an operator of the system) determines whether a progressive award triggering event occurs. In one such embodiment, a progressive award triggering event occurs based on an operator of the system making one or more inputs.

In certain embodiments, one or more actions (or inactions) undertaken by a user at least partially determines whether a progressive award triggering event occurs for an EGM associated with a progressive award. In one such embodiment, a progressive award triggering event occurs based on a user making one or more inputs requesting an occurrence of an event associated with an opportunity to win a progressive award. In such an embodiment, a progressive award triggering event occurs based on a user purchasing an occurrence of the event using one or more of an amount of funds, an amount of virtual currency and/or an amount of player tracking points. In one such embodiment, a progressive award triggering event occurs based on a user purchasing such an event for a static fee (in the form of an amount of funds, an amount of virtual currency and/or an amount of user tracking points). In another such embodiment, a progressive award triggering event occurs based on a user purchasing such an event for a dynamic fee (in the form of an amount of funds, an amount of virtual currency and/or an amount of player tracking points). In certain embodiments, different users have different requirements to cause an occurrence of an event associated with an opportunity to win a progressive award. In certain such embodiments, a user's wagering history at least partially determines whether or not that user is eligible to cause such an event to occur. In certain embodiments, which EGM the user is currently conducting a gaming session at at least partially determines whether or not that user is eligible to cause such an event to occur. In certain other embodiments, a user's non-wagering history, such as a user's historical non-wagering purchases and/or a user's historical location data (as determined via a mobile device of the user and/or a gaming establishment patron management system, such as a player tracking system) at least partially determines whether or not that user is eligible to cause such an event to occur.

In certain embodiments, a user's status (as determined by a gaming establishment patron management system, such as a player tracking system) at least partially determines one or more requirements to cause a progressive award triggering event to occur. In these embodiments, different users of different statuses are associated with different requirements to potentially cause a progressive award triggering event to occur. For example, all users associated with a player tracking status (or alternatively all users regardless of being assigned a player tracking status) are eligible to request an occurrence of an event associated with an opportunity to win a progressive award, but the respective costs to such users to cause the event to occur differs based on each user's respective player tracking status. In another example, certain users of certain player tracking statuses are eligible to request an occurrence of an event associated with an opportunity to win a progressive award, while certain other users of certain other player tracking statuses (or not player tracking status) are ineligible to request an occurrence of such an event.

In certain embodiments, the system enables qualifying users to request an occurrence of an event associated with an opportunity to win a progressive award and prevents non-qualifying users from making such requests. In certain such embodiments, the system enables users of a certain status to request an occurrence of an event associated with an opportunity to win a progressive award (e.g., a user must be a member of a gaming establishment loyalty program to make a request or a user must be of at least a certain status of a gaming establishment loyalty program to make a request). In certain embodiments, the system enables users who have maintained an active gaming session for a certain amount of time and/or over a certain quantity of games played to make such a request. In certain embodiments, the system enables users who have wagered a certain amount over a period of time to make such a request.

In certain embodiments, responsive to the progressive award triggering event not occurring, the system continues to monitor for any occurrences of a progressive award increment event which, as described above, cause an increase to the value of the progressive award which may result in an occurrence of a progressive award reassociation event. On the other hand, responsive to an occurrence of a progressive award triggering event associated with a particular EGM, the system causes the progressive award to be provided to a user of that EGM. In certain embodiments, following the progressive award triggering event, the system resets the value of the progressive award back to a reset value. In certain embodiments, following the progressive award triggering event, the system reduces the value of the progressive award by the amount of the progressive award provided to the user. In these embodiments, the occurrence of a progressive award triggering event results in an occurrence of a progressive award modification event (e.g., a progressive award reset event which reduces the amount of the progressive award).

It should be appreciated that the occurrence of the progressive award reset event is, in certain instances, associated with an occurrence of a progressive award reassociation event. In these embodiments, in a similar way to how the system reconfigures one or more EGMs to become associated with a progressive award based on an increased value of the progressive award, the system also reconfigures one or more EGMs to cease being associated with a progressive award based on a reduced value of the progressive award. In these embodiments as the progressive award becomes of less interest to users at EGMs currently associated with the progressive award, the system dynamically reconfigures such EGMs to not being associated with the progressive award. Since the association of a progressive award with an EGM is associated with certain fees paid by the gaming establishment operator, such a configuration enables the gaming establishment operator to avoid paying such fees when interest in the progressive award is relatively low based on the relatively low value of the progressive award.

In certain embodiments in which the progressive award reassociation event occurs based on a value of the progressive award, if a value of the progressive award reaches a decremented threshold value (e.g., the progressive award reset value) the system reconfigures the relationship between the progressive award and one or more EGMs by disassociating one or more EGMs from being associated with the progressive award. In certain such embodiments, the system employs a single decremented threshold value which, when reached, causes the system to disassociate one or more additional EGMs from the progressive award. In certain other embodiments, the system employs a plurality of decremented threshold values which, when each are reached, cause the system to disassociate one or more additional EGMs from the progressive award. In operation of such embodiments, the system monitors the value of the progressive award and determines, based on at least the monitored value of the progressive award relative to one or more decremented threshold values, whether to remove any EGMs from being associated with the progressive award. In these embodiments, as the progressive award is reduced in value (such as based on being reset or the progressive award being reduced when a portion of the progressive award is provided), the system removes more EGMs from being associated with the progressive award (and thus offers less users the opportunity to win the progressive award).

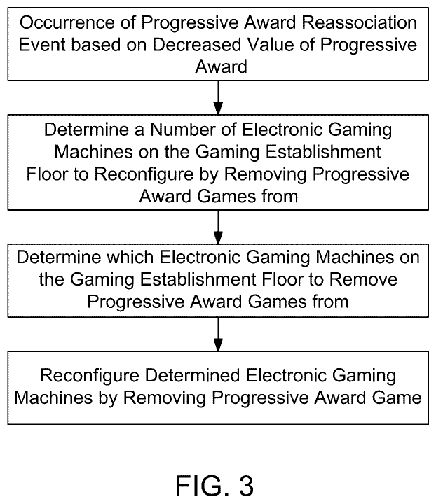

In certain embodiments, after determining that a progressive award reassociation event has occurred and one or more EGMs will be removed from being associated with the progressive award, the system determines a quantity of EGMs to disassociate from the progressive award. For example, as seen in FIG. 3, following an occurrence of a progressive award reassociation event (taking the form of a decrease of the progressive award), the system determines a number of EGMs on the gaming establishment floor to reconfigure by removing the progressive award game associated with an opportunity to win the progressive award. In certain embodiments in which one or more EGMs are disassociated from a progressive award if a value of the progressive award reaches a decremented threshold value, the system employs the value of the progressive award to determine the quantity of EGMs to disassociate. In certain such embodiments in which the system employs a plurality of decremented threshold values, the system removes a set quantity of EGMs from being associated with the progressive award when each decremented threshold value is reached.

In certain embodiments in which one or more EGMs are disassociated from a progressive award if a value of the progressive award reaches a decremented threshold value, the system additionally or alternatively dynamically determines the quantity of EGMs to disassociate based on demand feedback. In these embodiments, once the system determines that a progressive award reassociation event occurs, the system incrementally disassociates EGMs from being associated with the progressive award until the system determines that demand stabilizes. For example, following a determination to disassociate a quantity of EGMs from being associated with a progressive award, the system disassociates one EGM from the progressive award at a time until the system determines that play of the EGMs stabilizes (i.e., supply meets demand).

In certain other embodiments in which one or more EGMs are associated with a progressive award if a value of the progressive award reaches a decremented threshold value, the system dynamically determines the quantity of EGMs to disassociate from the progressive award based on certain gaming establishment floor metrics. In these embodiments, once the system determines that a progressive award reassociation event occurs, the system analyzes certain gaming establishment floor metrics (e.g., the total size of the gaming establishment floor and/or the total play occurring on the gaming establishment floor, anticipated play on the gaming establishment floor) and determines, based on such an analysis, how many EGMs to disassociate from the progressive award.

It should be appreciated that in certain instances, the determination of how many EGMs to disassociate from a progressive award is made against the backdrop of certain limits gaming establishment operators must comply with regarding the configuration of the gaming establishment floor. That is, gaming establishment operators have zero, one or more thresholds or minimums on the number of EGMs that may be associated with a progressive award and the system accounts for these thresholds or minimums in determining the quantity of EGMs to disassociate from a progressive award when demand falls.

Following the determination of a quantity of EGMs to reconfigure by disassociating from the progressive award, the system determines which specific EGMs to reconfigure. In these embodiments, the system employs one or more factors to determine which EGM(s) to cause to be disassociated from the progressive award. For example, as seen in FIG. 3, following a determination of a number of EGMs to remove progressive award games from, the system determines which EGMs to remove such progressive award games from. In certain embodiments, the system determines which EGMs to reconfigure to be disassociated from the progressive award based on the location of such EGMs relative to one or more EGMs already associated with (or disassociated from) the progressive award. In certain embodiments, the system additionally or alternatively determines which EGMs to reconfigure to be disassociated from the progressive award based on a compatibility of one or more EGMs with the ability to be modified to not longer offer an opportunity to win the progressive award. For example, the system employs the EGM manufacturer in the determination of which EGMs may be disassociated from the progressive award such that the system may remove progressive award games from EGMs of a first manufacturer but is prevented from removing progressive award games from EGMs of a second manufacturer.

In certain embodiments, following the determination of which specific EGMs to reconfigure based on the occurrence of the progressive award reassociation event, the system operates to cause a disassociation of the progressive award from such specific EGMs. For example, as seen in FIG. 3, the system enables the removal a progressive award game from the specifically selected target EGMs. In certain embodiments, if a progressive award reassociation event occurs and a determination to remove a specifically identified EGM from being associated with a progressive award also occurs, a configuration host interfaces with that specifically identified EGM to enable the disassociation of that EGM from the progressive award,

In certain such embodiments, the configuration host communicates a software package to that EGM which, upon receipt of the software package, installs a software package that enables the EGM to become disassociated from the progressive award. For example, if there are six EGMs on a gaming establishment floor that currently have the progressive configuration for a specific game through which the progressive award may be won, when the progressive award resets to a value of $20,000,000 (which results in an occurrence of a progressive award reassociation event associated with removing EGMs from being associated with the progressive award), the configuration host communicates a software package including a different game package (e.g., a non-progressive game package) to two specifically identified EGMs. In this example, the two EGMs download the package, configure how they operate based on the downloaded package and then disable users to play any games which offer any opportunities to win the progressive award. In certain other embodiments, the configuration host communicates a software package to that EGM which, upon receipt of the software package, uninstalls a software package which effectively disassociates that EGM from the progressive award.

In certain embodiments, rather than communicating a software package to install (or uninstall) to enable the disassociation of an EGM from a progressive award, the configuration host communicates to that EGM one or more commands to disable or otherwise deactivate a previously installed (or otherwise active) software package. In these embodiments, once deactivated, the EGM is disassociated from the progressive award. In certain such embodiments, the deactivated software package includes another game package to enable the EGM to execute another game not associated with any opportunity to win the progressive award (i.e., a non-progressive award game).

In certain embodiments, if a progressive award reassociation event occurs and a determination to remove a specifically identified EGM from being associated with a progressive award also occurs, a configuration host automatically interfaces with that specifically identified EGM to disable the association of that EGM with the progressive award. In certain other embodiments, if a progressive award reassociation event occurs and a determination to remove a specifically identified EGM from being associated with a progressive award also occurs, prior to interfacing with that specifically identified EGM to disable the association of that EGM with the progressive award, the configuration host notifies a gaming establishment operator (or other personnel associated with the progressive award) and requests an approval for such a reconfiguration of the EGM. For example, if the system decides to remove a progressive award game from an EGM on a gaming establishment floor, the system prompts an operator to approve the request. If the operator approves the request, the system proceeds as described above with reconfiguring the EGM to no longer be associated with the progressive award. On the other hand, if the operator does not approve the request, the system does not disassociate that EGM from the progressive award (and rather, in certain embodiments, determines alternative reconfiguration requests to present to the operator). In another example, if the system decides to remove a progressive award game from an EGM on a gaming establishment floor, the system prompts an operator to approve or adjust the request. In this example, such adjustments pertain to one or more of the number of EGMs being modified, the location of the EGMs being modified or the terms of the fees paid or received by the gaming establishment.

It should be appreciated that while generally described above as associating or disassociating a progressive award with a gaming device taking the form of an EGM, such as an EGM located in a gaming establishment, in the online space, no physical EGMs can be associated or disassociated with the progressive award. That is, while physical EGMs at a casino can be associated with a progressive award to satisfy increased demand when the progressive award has adequately increased in value, without any physical EGMs, which is not an option for an online casino. Accordingly, in certain embodiments in which the progressive award is maintained in association with an online game (such as an online (or mobile device application) wagering game for monetary credits, an online (or mobile device application) wagering game for non-monetary credits or an online (or mobile device application) social game), when the progressive award has adequately increased in value, the system operates to increase visibility of the progressive award so more users play for the progressive award. In certain embodiments, the system additionally or alternatively operates to incentivize users to engage with online play for the progressive award with a goal that the users continue playing after the progressive award has reset in value (and the incentive of winning an increased progressive award has expired).

In certain embodiments, the system employs the progressive award reassociation event to reallocate content displayed in association with an online casino. In these embodiments, rather than associating (or disassociating) a particular gaming device from a progressive award, the system associates (or disassociates) the progressive award from different components displayed in association with the online casino. In certain such embodiments, upon the system determining an occurrence of a progressive award reassociation event based on an increased value of a progressive award, the system operates with a server that maintains a lobby of the online casino to market the progressive award more (such as by designating the increased progressive award in a top banner of the lobby). In certain additional or alternative embodiments, a remote game server (“RGS”) that hosts a game associated with a progressive award that is launchable from the lobby operates to make an application programming interface call to a server that maintains the lobby when the RGS detects an occurrence of a progressive award reassociation event based on an increased value of a progressive award. In these embodiments, the application programming interface call directs the server that maintains the lobby to raise the visibility of the progressive award and/or the game associated with the progressive award in the online lobby.

In certain additional or alternative embodiments, the RGS is associated with a component (e.g., a widget, such as a marketing widget) loaded by one or more online games which can be used to market other games or opportunities from an online game provider that a user may find interesting. In these embodiments, upon an occurrence of a progressive award reassociation event based on an increased value of a progressive award, the RGS causes the component to display recommendations to raise the visibility of the progressive award and/or the game associated with the progressive award.

In certain additional or alternative embodiments, upon an occurrence of a progressive award reassociation event based on an increased value of a progressive award, the RGS offers certain benefits (e.g., a free play promotion) to certain (or all) users when such users launch a game associated with the progressive award. In these embodiments, the RGS notifies the server that maintains the lobby of the online casino that certain (or all) users are eligible for the benefits. Such a notification enables the server that maintains the lobby to display the offered benefits to users currently being displayed the lobby and/or users otherwise engaging with the online casino. In certain additional or alternative embodiments that employ one or more components loaded by one or more online games which can be used to market other games or opportunities from an online game provider, the system employs such components to notify users whom are eligible for the offered benefits (to entice such users to launch the game associated with the progressive award). In such embodiments, following a detection by the RGS of an occurrence of a progressive award reassociation event based on an increased value of a progressive award, the RGS creates a benefit and employs the loaded components (e.g., the loaded marketing widgets) to market the created benefit to eligible users. Accordingly and in view of the technical limitations associated with an online casino, the system of the present disclosure employs one or more attributes of a progressive award to modify how the online casino operates or is otherwise presented to users.

Accordingly, in certain embodiments, responsive to an occurrence of a progressive award modification event, the system modifies a value of a progressive award, and, responsive to the modified value of the progressive award being associated with a progressive award reassociation event, modifies any association of the progressive award with a component of an online casino lobby. In certain such embodiments in which the progressive award modification event includes a progressive award increment event, and modifying the value of the progressive award includes increasing the value of the progressive award, modifying any association of the progressive award with the component of the online casino lobby includes causing an enablement of a widget to display content associated with the progressive award. In such embodiments, the content associated with the progressive award includes at least one of a display of the increased value of the progressive award and graphics of a game associated with an opportunity to win the progressive award. In certain other embodiments in which the progressive award modification event includes a progressive award decrement event, and modifying the value of the progressive award includes decreasing the value of the progressive award, modifying any association between the progressive award with the component of the online casino lobby includes causing a disassociation of a widget from displaying any content associated with the progressive award. In certain of these embodiments, the component of the online casino lobby includes a widget and modifying any association of the progressive award with the component of the online casino lobby includes causing a modification of a frequency of content associated with the progressive award that is displayed by the widget. In certain additional or alternative embodiments, modifying the association of the progressive award with the component of the online casino lobby includes causing a modification of a benefit offered in association with the progressive award.

It should be appreciated that while the award that is dynamically associated (or disassociated) with one or more gaming devices is generally described as a progressive award, any suitable award, such as any monetary benefit and/or any non-monetary benefit, may be dynamically associated (or disassociated) with one or more gaming devices. In different embodiments, one or more of such awards include one or more of: a quantity of monetary credits, a quantity of non-monetary credits, a quantity of promotional credits, a quantity of player tracking points, an amount of virtual currency, an amount of cryptocurrency (e.g., 1 Satoshi), a modifier, such as a multiplier, a quantity of free plays of one or more games, a quantity of plays of one or more secondary or bonus games, a multiplier of a quantity of free plays of a game, one or more lottery based awards, such as lottery or drawing tickets, a wager match for one or more plays of one or more games, an increase in the average expected payback percentage for one or more plays of one or more games, one or more comps, such as a free dinner, a free night's stay at a hotel, a relatively high value product (e.g., a free car or vacation), one or more bonus credits usable for online play, a lump sum of player tracking points or credits, a multiplier for player tracking points or credits, an increase in a membership or player tracking level, one or more coupons or promotions usable within and/or outside of the gaming establishment (e.g., a 20% off coupon for use at a convenience store), a coupon for a reduced good, a coupon for a reduced service, a coupon for a complimentary good, a coupon for a complimentary service, virtual goods associated with the system, virtual goods not associated with the system, and/or an access code usable to unlock content on an internet.

In certain embodiments, the award dynamically associated (or disassociated) with one or more gaming devices includes one or more plays of a game. In different embodiments, the award dynamically associated (or disassociated) with one or more gaming devices includes one or more plays (e.g., a free play) of any suitable game, including, but not limited to: a play of any suitable slot game; a play of any suitable nudging wild symbol game, a play of any suitable expanding wild symbol game, a play of any suitable wheel game, a play of any suitable card game, a play of any suitable multi-hand card game, a play of any suitable offer and acceptance game, a play of any suitable award ladder game, a play of any suitable puzzle-type game, a play of any suitable persistence game, a play of any suitable selection game, a play of any suitable cascading symbols game, a play of any suitable ways to win game, a play of any suitable scatter pay game, a play of any suitable coin-pusher game, a play of any suitable elimination game, a play of any suitable stacked wilds game, a play of any suitable trail game, a play of any suitable bingo game, a play of any suitable video scratch-off game, a play of any suitable pick-until-complete game, a play of any suitable shooting simulation game, a play of any suitable racing game, a play of any suitable promotional game, a play of any suitable high-low game, a play of any suitable lottery game, a play of any suitable number selection game, a play of any suitable dice game, a play of any suitable skill game, a play of any suitable auction game, a play of any suitable reverse-auction game, a play of any suitable group game, a play of any suitable game in a service window, a play of any suitable game on a mobile device, and/or a play of any suitable game of the present disclosure.

In various embodiments, the award dynamically associated (or disassociated) with one or more gaming devices additionally or alternatively include one or more activations of one or more features which, if activated, modifies one or more components, aspects, or elements of a play of a game, such as modifies a game outcome (e.g., the symbols evaluated for the play of the game), modifies the paytable utilized for the play of the game and/or modifies any award determined for the play of the game. In different embodiments, such features include, but are not limited to: a modifier, such as a multiplier, feature; a feature modifying a placed wager amount; a feature modifying a placed side wager amount; a feature modifying a number of wagered on paylines; a feature modifying a wager placed on one or more paylines (or on one or more designated paylines); a feature modifying a number of ways to win wagered on; a feature modifying a wager placed on one or more ways to win (or on one or more designated ways to win); a feature modifying a paytable utilized for a play of a game; a feature modifying an average expected payback percentage of a play of a game; a feature modifying an average expected payout of a play of a game; a feature modifying one or more awards available; a feature modifying a range of awards available; a feature modifying a type of awards available; a feature modifying one or more progressive awards; a feature modifying which progressive awards are available to be won; a feature modifying one or more modifiers, such as multipliers, available; a feature modifying a generated outcome (or a designated generated outcome); a feature modifying a generated outcome (or a designated generated outcome) associated with an award over a designated value; a feature modifying a generated outcome (or a designated generated outcome) on a designated payline; a feature modifying a generated outcome (or a designated generated outcome) in a scatter configuration; a feature modifying a winning way to win (or a designated winning way to win); a feature modifying a designated symbol or symbol combination; a feature modifying a generation of a designated symbol or symbol combination on a designated payline; a feature modifying a generation of a designated symbol or symbol combination in a scatter configuration; a feature modifying a quantity of picks in a selection game; a feature modifying a quantity of offers in an offer and acceptance game; a feature modifying a quantity of moves in a trail game; a feature modifying an amount of free spins provided; a feature modifying a game terminating or ending condition; a feature modifying how one or more aspects of one or more games (e.g., colors, speeds, sound) are displayed to a player; and/or a feature modifying any game play feature associated with any play of any game of the present disclosure.

In various embodiments, the award dynamically associated (or disassociated) with one or more gaming devices additionally or alternatively include any suitable feature that represents, if activated, one or more additional awards independent of the play of the game and/or one or more opportunities to win one or more additional awards independent of the play of the game. In different embodiments, such features include, but are not limited to: a feature that triggers a secondary or bonus game; a feature that provides an additional award amount to a player; a feature modifying an amount of credits of a credit balance; a feature modifying an amount of promotional credits; a feature modifying a rate of earning player tracking points; a feature modifying a triggering event of a play of a secondary or bonus game; a feature modifying an activation of a secondary or bonus display (such as an award generator); a feature modifying a quantity of activations of a secondary or bonus display (e.g., a feature modifying a quantity of spins of an award generator); a feature modifying a quantity of sections of a secondary or bonus display (e.g., a feature modifying a quantity of sections of an award generator); a feature modifying one or more awards of a secondary or bonus display; a feature modifying an activation of a community award generator; a feature modifying a quantity of activations of a community award generator; a feature modifying a quantity of sections of a community award generator; a feature modifying one or more awards of a community award generator; and/or a feature modifying a generated outcome (or a designated generated outcome) in a secondary game.

It should be appreciated that in different embodiments, one or more of: whether a game triggering event, a progressive award increment event, a progressive award triggering event, a progressive award reassociation event, and/or a progressive award reset event occurs; one or more incremented threshold values; one or more decremented threshold values; a quantity of gaming devices to be associated with a progressive award; a quantity of gaming devices to be disassociated from a progressive award; which gaming devices to associate with a progressive award; which gaming device to disassociate from a progressive award; one or more fees assessed in association with a progressive award; and/or any determination of the present disclosure is/are predetermined, randomly determined, randomly determined based on one or more weighted percentages, determined based on a generated symbol or symbol combination, determined independent of a generated symbol or symbol combination, determined based on a random determination by a server, determined independent of a random determination by the server, determined based on a random determination at the system, determined independent of a random determination at the system, determined based on at least one play of at least one game, determined independent of at least one play of at least one game, determined based on a player's selection, determined independent of a player's selection, determined based on one or more side wagers placed, determined independent of one or more side wagers placed, determined based on the player's primary game wager, determined independent of the player's primary game wager, determined based on time (such as the time of day), determined independent of time (such as the time of day), determined based on an amount of coin-in accumulated in one or more pools, determined independent of an amount of coin-in accumulated in one or more pools, determined based on a status of the player (i.e., a player tracking status), determined independent of a status of the player (i.e., a player tracking status), determined based on one or more other determinations of the present disclosure, determined independent of any other determination of the present disclosure or determined based on any other suitable method or criteria.

In different embodiments, as described above, a game triggering event, a progressive award increment event, a progressive award triggering event, a progressive award reassociation event, and/or a progressive award reset event occurs based on an outcome associated with one or more plays of any primary games or any secondary games. In one embodiment, such determinations are symbol driven based on the generation of one or more designated symbols or symbol combinations. In various embodiments, a generation of a designated symbol (or sub-symbol) or a designated set of symbols (or sub-symbols) over one or more plays of a primary game (and/or a secondary game) causes such conditions to be satisfied and/or one or more of such events to occur.

In different embodiments, the system does not provide any apparent reasons to the players for an occurrence of a game triggering event, a progressive award increment event, a progressive award triggering event, a progressive award reassociation event, and/or a progressive award reset event. In these embodiments, such determinations are not triggered by an event in a primary game or based specifically on any of the plays of any primary games or any secondary games. That is, these events occur without any explanation or alternatively with simple explanations.

In one such embodiment, a game triggering event, a progressive award increment event, a progressive award triggering event, a progressive award reassociation event, and/or a progressive award reset event occurs based on an amount of coin-in. In this embodiment, the system determines if an amount of coin-in reaches or exceeds a designated amount of coin-in (i.e., a threshold coin-in amount). Upon the amount of coin-in wagered reaching or exceeding the threshold coin-in amount, the system causes one or more of such events or conditions to occur. In another such embodiment, a game triggering event, a progressive award increment event, a progressive award triggering event, a progressive award reassociation event, and/or a progressive award reset event occurs based on an amount of virtual currency-in. In this embodiment, the system determines if an amount of virtual currency-in wagered reaches or exceeds a designated amount of virtual currency-in (i.e., a threshold virtual currency-in amount). Upon the amount of virtual currency-in wagered reaching or exceeding the threshold virtual currency-in amount, the system causes one or more of such events or conditions to occur. In different embodiments, the threshold coin-in amount and/or the threshold virtual currency-in amount is predetermined, randomly determined, determined based on a player's status (such as determined through a player tracking system), determined based on a generated symbol or symbol combination, determined based on a random determination by the central controller, determined based on a random determination at the gaming device, determined based on one or more side wagers placed, determined based on the player's primary game wager, determined based on time (such as the time of day) or determined based on any other suitable method or criteria.

In one such embodiment, a game triggering event, a progressive award increment event, a progressive award triggering event, a progressive award reassociation event, and/or a progressive award reset event occurs based on an amount of coin-out. In this embodiment, the system determines if an amount of coin-out reaches or exceeds a designated amount of coin-out (i.e., a threshold coin-out amount). Upon the amount of coin-out reaching or exceeding the threshold coin-out amount, the system causes one or more of such events or conditions to occur. In another such embodiment, a game triggering event, a progressive award increment event, a progressive award triggering event, a progressive award reassociation event, and/or a progressive award reset event occurs based on an amount of virtual currency-out. In this embodiment, the system determines if an amount of virtual currency-out reaches or exceeds a designated amount of virtual currency-out (i.e., a threshold virtual currency-out amount). Upon the amount of virtual currency-out reaching or exceeding the threshold virtual currency-out amount, the system causes one or more of such events or conditions to occur. In different embodiments, the threshold coin-out amount and/or the threshold virtual currency-out amount is predetermined, randomly determined, determined based on a player's status (such as determined through a player tracking system), determined based on a generated symbol or symbol combination, determined based on a random determination by the central controller, determined based on a random determination at the gaming device, determined based on one or more side wagers placed, determined based on the player's primary game wager, determined based on time (such as the time of day) or determined based on any other suitable method or criteria.

In different embodiments, a game triggering event, a progressive award increment event, a progressive award triggering event, a progressive award reassociation event, and/or a progressive award reset event occurs based on a predefined variable reaching a defined parameter threshold. For example, when a quantity of players have played an EGM (ascertained from a player tracking system), one or more of such events or conditions occur. In different embodiments, the predefined parameter thresholds include a length of time, a length of time after a certain dollar amount is hit, a wager level threshold for a specific device (which gaming device is the first to contribute a predetermined amount), a number of gaming devices active, or any other parameter that defines a suitable threshold.

In different embodiments, a game triggering event, a progressive award increment event, a progressive award triggering event, a progressive award reassociation event, and/or a progressive award reset event occurs based on a quantity of games played. In this embodiment, a quantity of games played is set for when one or more of such events or conditions will occur. In one embodiment, such a set quantity of games played is based on historic data.

In different embodiments, a game triggering event, a progressive award increment event, a progressive award triggering event, a progressive award reassociation event, and/or a progressive award reset event occurs based on time. In this embodiment, a time is set for when one or more of such events or conditions will occur. In one embodiment, such a set time is based on historic data.

In different embodiments, a game triggering event, a progressive award increment event, a progressive award triggering event, a progressive award reassociation event, and/or a progressive award reset event occurs based upon system operator defined player eligibility parameters stored on a player tracking system (such as via a player tracking card or other suitable manner). In this embodiment, the parameters for eligibility are defined by the system operator based on any suitable criterion. In one embodiment, the system recognizes the player's identification (via the player tracking system) when the player inserts or otherwise associates their player tracking card in the EGM and/or logs into the player tracking system using a mobile device, such as a personal gaming device. The system determines the player tracking level of the player and if the current player tracking level defined by the system operator is eligible for one or more of such events or conditions. In one embodiment, the system operator defines minimum bet levels required for such events or conditions to occur based on the player's card level.

In different embodiments, a game triggering event, a progressive award increment event, a progressive award triggering event, a progressive award reassociation event, and/or a progressive award reset event occurs based on a system determination, including one or more random selections by the central controller. For example, as described above, the system tracks all active EGMs and the wagers they placed, wherein based on the EGM's state as well as one or more wager pools associated with the EGM, the system determines whether to one or more of such events or conditions will occur. In one such embodiment, the player who consistently places a higher wager is more likely to be associated with an occurrence of one or more of such events or conditions than a player who consistently places a minimum wager. It should be appreciated that the criteria for determining whether a player is in active status or inactive status for determining if one or more of such events occur may the same as, substantially the same as, or different than the criteria for determining whether a player is in active status or inactive status for another one of such events to occur.

In different embodiments, a game triggering event, a progressive award increment event, a progressive award triggering event, a progressive award reassociation event, and/or a progressive award reset event occurs based on a determination of if any numbers allotted to a gaming device match a randomly selected number. In this embodiment, upon or prior to each play of each gaming device, a gaming device selects a random number from a range of numbers and during each primary game, the gaming device allocates the first N numbers in the range, where N is the number of credits bet by the player in that primary game. At the end of the primary game, the randomly selected number is compared with the numbers allocated to the player and if a match occurs, one or more of such events or conditions occur.

It should be appreciated that any suitable manner of causing a game triggering event, a progressive award increment event, a progressive award triggering event, a progressive award reassociation event, and/or a progressive award reset event to occur may be implemented in accordance with the system and method of the present disclosure. It should be further appreciated that one or more of the above-described triggers pertaining to a game triggering event, a progressive award increment event, a progressive award triggering event, a progressive award reassociation event, and/or a progressive award reset event occurring may be combined in one or more different embodiments.

The above-described embodiments of the present disclosure may be implemented in accordance with or in conjunction with one or more of a variety of different types of systems, such as, but not limited to, those described below.

The present disclosure contemplates a variety of different systems each having one or more of a plurality of different features, attributes, or characteristics. A “system” as used herein refers to various configurations of: (a) one or more servers; (b) one or more electronic gaming machines such as those located on a casino floor; and/or (c) one or more personal gaming devices. Thus, in various embodiments, the system of the present disclosure includes: (a) one or more electronic gaming machines in combination with one or more servers; (b) one or more personal gaming devices in combination with one or more servers; (c) one or more personal gaming devices in combination with one or more electronic gaming machines; (d) one or more personal gaming devices, one or more electronic gaming machines, and one or more servers in combination with one another; (e) a single electronic gaming machine; (f) a plurality of electronic gaming machines in combination with one another; (g) a single personal gaming device; (h) a plurality of personal gaming devices in combination with one another; (i) a single server; and/or (j) a plurality of servers in combination with one another. For brevity and clarity and unless specifically stated otherwise, “EGM” as used herein represents one EGM or a plurality of EGMs, “personal gaming device” as used herein represents one personal gaming device or a plurality of personal gaming devices, and “server” as used herein represents one server or a plurality of servers.

As noted above, in various embodiments, the system includes an EGM (or personal gaming device) in combination with a server. In such embodiments, the EGM (or personal gaming device) is configured to communicate with the server through a data network or remote communication link. In certain such embodiments, the EGM (or personal gaming device) is configured to communicate with another EGM (or personal gaming device) through the same data network or remote communication link or through a different data network or remote communication link. For example, the system includes a plurality of EGMs that are each configured to communicate with a server through a data network.

In certain embodiments in which the system includes an EGM (or personal gaming device) in combination with a server, the server is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the server. The at least one processor of that EGM (or personal gaming device) is configured to execute the events, messages, or commands represented by such data or signals in conjunction with the operation of the EGM (or personal gaming device). Moreover, the at least one processor of the server is configured to transmit and receive data or signals representing events, messages, commands, or any other suitable information between the server and the EGM (or personal gaming device). The at least one processor of the server is configured to execute the events, messages, or commands represented by such data or signals in conjunction with the operation of the server. One, more than one, or each of the functions of the server may be performed by the at least one processor of the EGM (or personal gaming device). Further, one, more than one, or each of the functions of the at least one processor of the EGM (or personal gaming device) may be performed by the at least one processor of the server.

In certain such embodiments, computerized instructions for controlling any games (such as any primary or base games and/or any secondary or bonus games) displayed by the EGM (or personal gaming device) are executed by the server. In such “thin client” embodiments, the server remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the server to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the system includes an EGM (or personal gaming device) and a server, computerized instructions for controlling any primary or base games displayed by the EGM (or personal gaming device) are communicated from the server to the EGM (or personal gaming device) in a thick client configuration, and computerized instructions for controlling any secondary or bonus games or other functions displayed by the EGM (or personal gaming device) are executed by the server in a thin client configuration.

In certain embodiments in which the system includes: (a) an EGM (or personal gaming device) configured to communicate with a server through a data network; and/or (b) a plurality of EGMs (or personal gaming devices) configured to communicate with one another through a data network, the data network is a local area network (LAN) in which the EGMs (or personal gaming devices) are located substantially proximate to one another and/or the server. In one example, the EGMs (or personal gaming devices) and the server are located in a gaming establishment or a portion of a gaming establishment.

In other embodiments in which the system includes: (a) an EGM (or personal gaming device) configured to communicate with a server through a data network; and/or (b) a plurality of EGMs (or personal gaming devices) configured to communicate with one another through a data network, the data network is a wide area network (WAN) in which one or more of the EGMs (or personal gaming devices) are not necessarily located substantially proximate to another one of the EGMs (or personal gaming devices) and/or the server. For example, one or more of the EGMs (or personal gaming devices) are located: (a) in an area of a gaming establishment different from an area of the gaming establishment in which the server is located; or (b) in a gaming establishment different from the gaming establishment in which the server is located. In another example, the server is not located within a gaming establishment in which the EGMs (or personal gaming devices) are located. In certain embodiments in which the data network is a WAN, the system includes a server and an EGM (or personal gaming device) each located in a different gaming establishment in a same geographic area, such as a same city or a same state. Systems in which the data network is a WAN are substantially identical to systems in which the data network is a LAN, though the quantity of EGMs (or personal gaming devices) in such systems may vary relative to one another.

In further embodiments in which the system includes: (a) an EGM (or personal gaming device) configured to communicate with a server through a data network; and/or (b) a plurality of EGMs (or personal gaming devices) configured to communicate with one another through a data network, the data network is an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the server identifies a player before enabling that player to place any wagers on any plays of any wagering games. In one example, the server identifies the player by requiring a player account of the player to be logged into via an input of a unique username and password combination assigned to the player. The server may, however, identify the player in any other suitable manner, such as by validating a player tracking identification number associated with the player; by reading a player tracking card or other smart card inserted into a card reader (as described below); by validating a unique player identification number associated with the player by the server; or by identifying the EGM (or personal gaming device), such as by identifying the MAC address or the IP address of the Internet facilitator. In various embodiments, once the server identifies the player, the server enables placement of one or more wagers on one or more plays of one or more primary or base games and/or one or more secondary or bonus games, and displays those plays via the Internet browser of the EGM (or personal gaming device).

The server and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

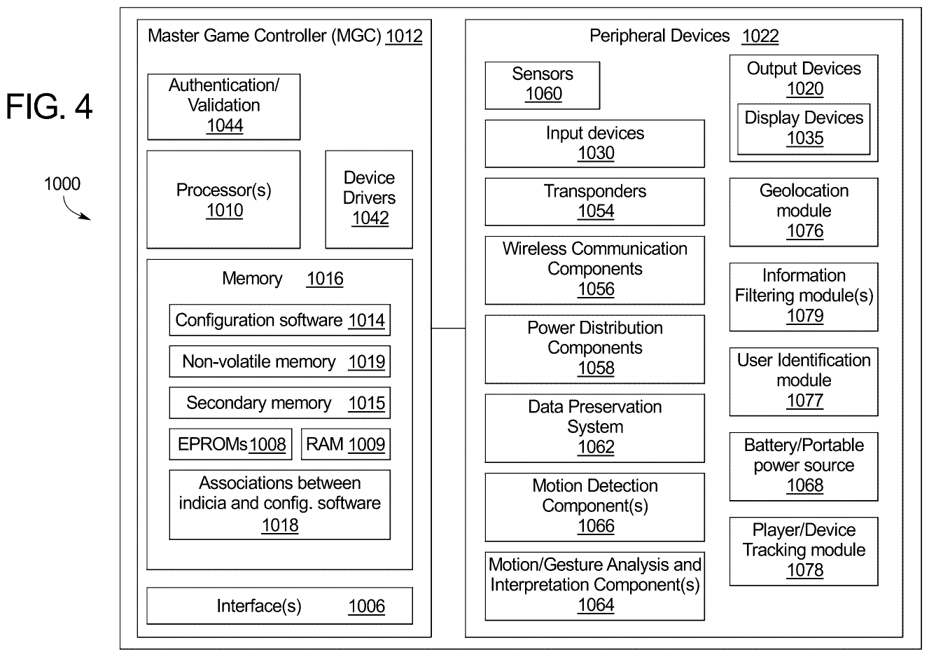

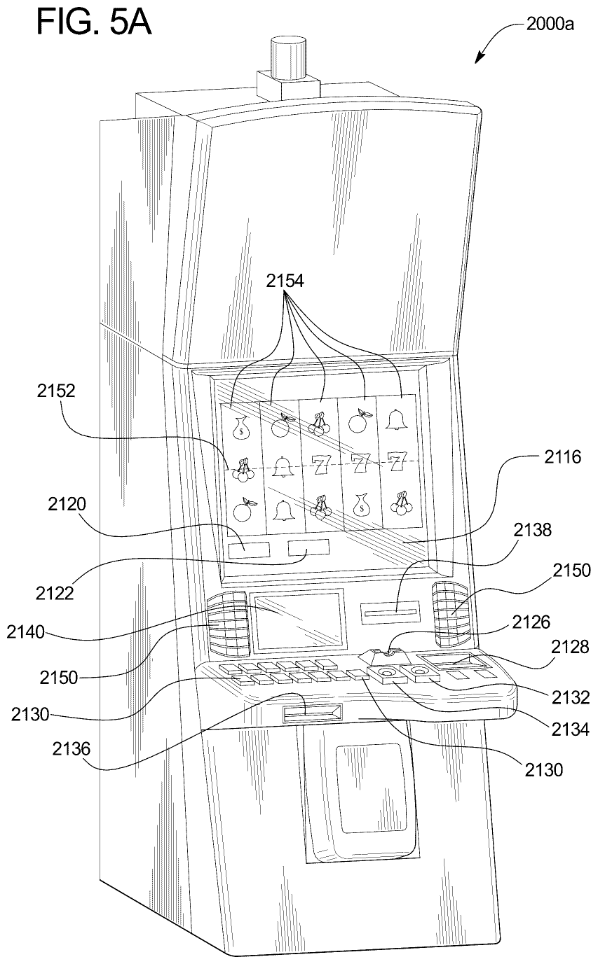

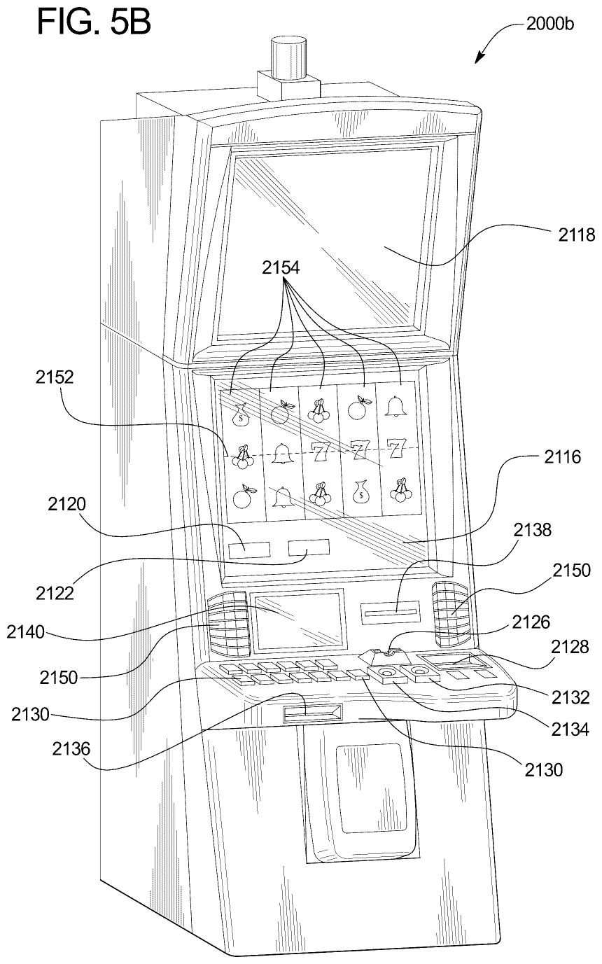

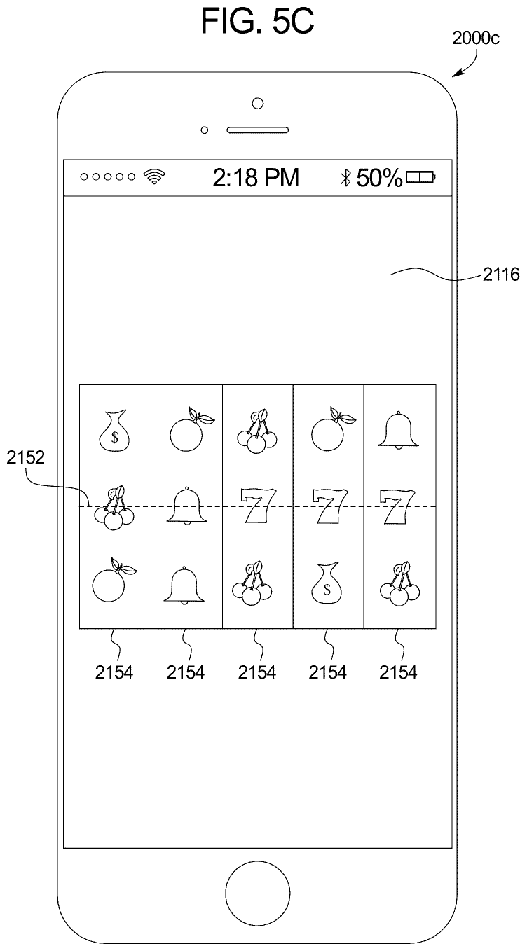

FIG. 4 is a block diagram of an example EGM 1000 and FIGS. 5A and 5B include two different example EGMs 2000a and 2000b. The EGMs 1000, 2000a, and 2000b are merely example EGMs, and different EGMs may be implemented using different combinations of the components shown in the EGMs 1000, 2000a, and 2000b. Although the below refers to EGMs, in various embodiments personal gaming devices (such as personal gaming device 2000c of FIG. 5C) may include some or all of the below components.

In these embodiments, the EGM 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the EGM; (3) accessing memory to configure or reconfigure game parameters in the memory according to indicia read from the EGM; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the EGM (described below), while in other embodiments at least one component of the master gaming controller 1012 resides outside of the housing of the EGM.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the EGM of the present disclosure. In certain embodiments, the at least one memory device 1016 resides within the housing of the EGM (described below), while in other embodiments at least one component of the at least one memory device 1016 resides outside of the housing of the EGM. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device 1016 is configured to store, for example: (1) configuration software 1014, such as all the parameters and settings for a game playable on the EGM; (2) associations 1018 between configuration indicia read from an EGM with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the EGM to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device 1016 is configured to store program code and instructions executable by the at least one processor of the EGM to control the EGM. The at least one memory device 1016 of the EGM also stores other operating data, such as image data, event data, input data, random number generators (RNGs) or pseudo-RNGs, paytable data or information, and/or applicable game rules that relate to the play of one or more games on the EGM. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an Internet or intranet).

The at least one memory device 1016 also stores a plurality of device drivers 1042. Examples of different types of device drivers include device drivers for EGM components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the EGM. Non-limiting examples of communication protocols used to implement the device drivers include Netplex, USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the EGM loads the new device driver from the at least one memory device to enable communication with the new device. For instance, one type of card reader in the EGM can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new parameters, new settings for existing parameters, new settings for new parameters, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified EGM components and/or information, such as hardware components, software components, firmware components, peripheral device components, user input device components, information received from one or more user input devices, information stored in the at least one memory device 1016, etc.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one user identification module 1077; (13) at least one player/device tracking module 1078; and (14) at least one information filtering module 1079.

The at least one output device 1020 includes at least one display device 1035 configured to display any game(s) displayed by the EGM and any suitable information associated with such game(s). In certain embodiments, the display devices are connected to or mounted on a housing of the EGM (described below). In various embodiments, the display devices serve as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 2000a illustrated in FIG. 5A includes a central display device 2116, a player tracking display 2140, a credit display 2120, and a bet display 2122. The example EGM 2000b illustrated in FIG. 5B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touchscreen with an associated touch-screen controller. The display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the EGM receives an actuation of a cashout device (described below), the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example EGMs 2000a and 2000b illustrated in FIGS. 5A and 5B each include a ticket printer and dispenser 2136.

In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the EGM, such as an attract mode. The example EGMs 2000a and 2000b illustrated in FIGS. 5A and 5B each include a plurality of speakers 2150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

The at least one input device 1030 may include any suitable device that enables an input signal to be produced and received by the at least one processor 1010 of the EGM.

In one embodiment, the at least one input device 1030 includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. The example EGMs 2000a and 2000b illustrated in FIGS. 5A and 5B each include a combined bill and ticket acceptor 2128 and a coin slot 2126.

In one embodiment, the at least one input device 1030 includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. When the EGM is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously placed wager on a play of a game. A further such wagering or betting device is a bet one device that, when actuated, causes the EGM to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game. The example EGMs 2000a and 2000b illustrated in FIGS. 5A and 5B each include a game play activation device in the form of a game play initiation button 2132. In other embodiments, the EGM begins game play automatically upon appropriate funding rather than upon utilization of the game play activation device.

In other embodiments, the at least one input device 1030 includes a cashout device. In various embodiments, the cashout device is: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). When the EGM receives an actuation of the cashout device from a player and the player has a positive (i.e., greater-than-zero) credit balance, the EGM initiates a payout associated with the player's credit balance. The example EGMs 2000a and 2000b illustrated in FIGS. 5A and 5B each include a cashout device in the form of a cashout button 2134.

In various embodiments, the at least one input device 1030 includes a plurality of buttons that are programmable by the EGM operator to, when actuated, cause the EGM to perform particular functions. For instance, such buttons may be hard keys, programmable soft keys, or icons icon displayed on a display device of the EGM (described below) that are actuatable via a touch screen of the EGM (described below) or via use of a suitable input device of the EGM (such as a mouse or a joystick). The example EGMs 2000a and 2000b illustrated in FIGS. 5A and 5B each include a plurality of such buttons 2130.

In certain embodiments, the at least one input device 1030 includes a touchscreen coupled to a touch-screen controller or other touch-sensitive display overlay to enable interaction with any images displayed on a display device (as described below). One such input device is a conventional touch-screen button panel. The touchscreen and the touch-screen controller are connected to a video controller. In these embodiments, signals are input to the EGM by touching the touch screen at the appropriate locations.

In embodiments including a player tracking system, as further described below, the at least one input device 1030 includes a card reader in communication with the at least one processor of the EGM. The example EGMs 2000a and 2000b illustrated in FIGS. 5A and 5B each include a card reader 2138. The card reader is configured to read a player identification card inserted into the card reader.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more user input devices near the EGM. In one embodiment, a user input device docking region is provided, and includes a power distribution component that is configured to recharge a user input device without requiring metal-to-metal contact. In one embodiment, the at least one power distribution component 1058 is configured to distribute power to one or more internal components of the EGM, such as one or more rechargeable power sources (e.g., rechargeable batteries) located at the EGM.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the EGM; detecting the presence and/or identity of various persons (e.g., players, casino employees, etc.), devices (e.g., user input devices), and/or systems within a predetermined proximity to the EGM.

The at least one data preservation component 1062 is configured to detect or sense one or more events and/or conditions that, for example, may result in damage to the EGM and/or that may result in loss of information associated with the EGM. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected player movements and/or gestures to determine appropriate player input information relating to the detected player movements and/or gestures. For example, in one embodiment, the at least one motion/gesture analysis and interpretation component 1064 is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source 1068 enables the EGM to operate in a mobile environment. For example, in one embodiment, the EGM 300 includes one or more rechargeable batteries.

The at least one geolocation module 1076 is configured to acquire geolocation information from one or more remote sources and use the acquired geolocation information to determine information relating to a relative and/or absolute position of the EGM. For example, in one implementation, the at least one geolocation module 1076 is configured to receive GPS signal information for use in determining the position or location of the EGM. In another implementation, the at least one geolocation module 1076 is configured to receive multiple wireless signals from multiple remote devices (e.g., EGMs, servers, wireless access points, etc.) and use the signal information to compute position/location information relating to the position or location of the EGM.

The at least one user identification module 1077 is configured to determine the identity of the current user or current owner of the EGM. For example, in one embodiment, the current user is required to perform a login process at the EGM in order to access one or more features. Alternatively, the EGM is configured to automatically determine the identity of the current user based on one or more external signals, such as an RFID tag or badge worn by the current user and that provides a wireless signal to the EGM that is used to determine the identity of the current user. In at least one embodiment, various security features are incorporated into the EGM to prevent unauthorized users from accessing confidential or sensitive information.

The at least one information filtering module 1079 is configured to perform filtering (e.g., based on specified criteria) of selected information to be displayed at one or more displays 1035 of the EGM.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example EGMs 2000a and 2000b illustrated in FIGS. 5A and 5B, the EGM has a support structure, housing, or cabinet that provides support for a plurality of the input devices and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs 2000a and 2000b shown in FIGS. 5A and 5B, EGMs may have varying housing and display configurations.

In certain embodiments, the EGM is a device that has obtained approval from a regulatory gaming commission, and in other embodiments, the EGM is a device that has not obtained approval from a regulatory gaming commission.

The EGMs described above are merely three examples of different types of EGMs. Certain of these example EGMs may include one or more elements that may not be included in all systems, and these example EGMs may not include one or more elements that are included in other systems. For example, certain EGMs include a coin acceptor while others do not.

In various embodiments, an EGM may be implemented in one of a variety of different configurations. In various embodiments, the EGM may be implemented as one of: (a) a dedicated EGM in which computerized game programs executable by the EGM for controlling any primary or base games (referred to herein as “primary games”) and/or any secondary or bonus games or other functions (referred to herein as “secondary games”) displayed by the EGM are provided with the EGM before delivery to a gaming establishment or before being provided to a player; and (b) a changeable EGM in which computerized game programs executable by the EGM for controlling any primary games and/or secondary games displayed by the EGM are downloadable or otherwise transferred to the EGM through a data network or remote communication link; from a USB drive, flash memory card, or other suitable memory device; or in any other suitable manner after the EGM is physically located in a gaming establishment or after the EGM is provided to a player.

As generally explained above, in various embodiments in which the system includes a server and a changeable EGM, the at least one memory device of the server stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the server is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the server to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the system generates the game outcome(s) and/or the award(s) to be provided based on the associated probabilities. In these embodiments, since the system generates game outcomes and/or awards randomly or based on one or more probability calculations, there is no certainty that the system will ever provide any specific game outcome and/or award.

In certain embodiments, the system maintains one or more predetermined pools or sets of predetermined game outcomes and/or awards. In certain such embodiments, upon generation or receipt of a game outcome and/or award request, the system independently selects one of the predetermined game outcomes and/or awards from the one or more pools or sets. The system flags or marks the selected game outcome and/or award as used. Once a game outcome or an award is flagged as used, it is prevented from further selection from its respective pool or set; that is, the system does not select that game outcome or award upon another game outcome and/or award request. The system provides the selected game outcome and/or award.

In certain embodiments, the system determines a predetermined game outcome and/or award based on the results of a bingo, keno, or lottery game. In certain such embodiments, the system utilizes one or more bingo, keno, or lottery games to determine the predetermined game outcome and/or award provided for a primary game and/or a secondary game. The system is provided or associated with a bingo card. Each bingo card consists of a matrix or array of elements, wherein each element is designated with separate indicia. After a bingo card is provided, the system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards.

In certain embodiments in which the system includes a server and an EGM, the EGM is configured to communicate with the server for monitoring purposes only. In such embodiments, the EGM determines the game outcome(s) and/or award(s) to be provided in any of the manners described above, and the server monitors the activities and events occurring on the EGM. In one such embodiment, the system includes a real-time or online accounting and gaming information system configured to communicate with the server. In this embodiment, the accounting and gaming information system includes: (a) a player database configured to store player profiles, (b) a player tracking module configured to track players (as described below), and (c) a credit system configured to provide automated transactions.

As noted above, in various embodiments, the system includes one or more executable game programs executable by at least one processor of the system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the system. In certain such embodiments, the system includes one or more paylines associated with the reels. The example EGM 2000b shown in FIG. 5B includes a payline 1152 and a plurality of reels 1154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The system enables a wager to be placed on one or more of such paylines to activate such paylines. In other embodiments in which one or more paylines are formed between at least two adjacent symbol display areas, the system enables a wager to be placed on a plurality of symbol display areas, which activates those symbol display areas.

In various embodiments, the system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided.

In various embodiments, as described above, the system includes a progressive award. Typically, a progressive award includes an initial amount and an additional amount funded through a portion of each wager placed to initiate a play of a primary game. When one or more triggering events occurs, the system provides at least a portion of the progressive award. After the system provides the progressive award, an amount of the progressive award is reset to the initial amount and a portion of each subsequent wager is allocated to the next progressive award.

As generally noted above, in addition to providing winning credits or other awards for one or more plays of the primary game(s), in various embodiments the system provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). The secondary game(s) may be any type of suitable game, either similar to or completely different from the primary game.

In various embodiments, the system automatically provides or initiates the secondary game upon the occurrence of a triggering event or the satisfaction of a qualifying condition. In other embodiments, the system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. Any suitable triggering event or qualifying condition or any suitable combination of a plurality of different triggering events or qualifying conditions may be employed.

In other embodiments, at least one processor of the system randomly determines when to provide one or more plays of one or more secondary games. In one such embodiment, no apparent reason is provided for providing the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards.

In various embodiments, the system includes one or more player tracking systems. Such player tracking systems enable operators of the system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the system to begin a gaming session, the card reader reads the player identification number off the player tracking card to identify the player. The system timely tracks any suitable information or data relating to the identified player's gaming session. The system also timely tracks when the player tracking card is removed to conclude play for that gaming session. In another embodiment, rather than requiring insertion of a player tracking card into the card reader, the system utilizes one or more portable devices, such as a mobile phone, a radio frequency identification tag, or any other suitable wireless device, to track when a gaming session begins and ends. In another embodiment, the system utilizes any suitable biometric technology or ticket technology to track when a gaming session begins and ends.

In such embodiments, during one or more gaming sessions, the system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

In various embodiments, the system includes one or more servers configured to communicate with a personal gaming device—such as a smartphone, a tablet computer, a desktop computer, or a laptop computer—to enable web-based game play using the personal gaming device. In various embodiments, the player must first access a gaming website via an Internet browser of the personal gaming device or execute an application (commonly called an “app”) installed on the personal gaming device before the player can use the personal gaming device to participate in web-based game play. In certain embodiments, the one or more servers and the personal gaming device operate in a thin-client environment. In these embodiments, the personal gaming device receives inputs via one or more input devices (such as a touch screen and/or physical buttons), the personal gaming device sends the received inputs to the one or more servers, the one or more servers make various determinations based on the inputs and determine content to be displayed (such as a randomly determined game outcome and corresponding award), the one or more servers send the content to the personal gaming device, and the personal gaming device displays the content.

In certain such embodiments, the one or more servers must identify the player before enabling game play on the personal gaming device (or, in some embodiments, before enabling monetary wager-based game play on the personal gaming device). In these embodiments, the player must identify herself to the one or more servers, such as by inputting the player's unique username and password combination, providing an input to a biometric sensor (e.g., a fingerprint sensor, a retinal sensor, a voice sensor, or a facial-recognition sensor), or providing any other suitable information.

Once identified, the one or more servers enable the player to establish an account balance from which the player can draw credits usable to wager on plays of a game. In certain embodiments, the one or more servers enable the player to initiate an electronic funds transfer to transfer funds from a bank account to the player's account balance. In other embodiments, the one or more servers enable the player to make a payment using the player's credit card, debit card, or other suitable device to add money to the player's account balance. In other embodiments, the one or more servers enable the player to add money to the player's account balance via a peer-to-peer type application, such as PayPal or Venmo. The one or more servers also enable the player to cash out the player's account balance (or part of it) in any suitable manner, such as via an electronic funds transfer, by initiating creation of a paper check that is mailed to the player, or by initiating printing of a voucher at a kiosk in a gaming establishment.

In certain embodiments, the one or more servers include a payment server that handles establishing and cashing out players'account balances and a separate game server configured to determine the outcome and any associated award for a play of a game. In these embodiments, the game server is configured to communicate with the personal gaming device and the payment device, and the personal gaming device and the payment device are not configured to directly communicate with one another. In these embodiments, when the game server receives data representing a request to start a play of a game at a desired wager, the game server sends data representing the desired wager to the payment server. The payment server determines whether the player's account balance can cover the desired wager (i.e., includes a monetary balance at least equal to the desired wager).

If the payment server determines that the player's account balance cannot cover the desired wager, the payment server notifies the game server, which then instructs the personal gaming device to display a suitable notification to the player that the player's account balance is too low to place the desired wager. If the payment server determines that the player's account balance can cover the desired wager, the payment server deducts the desired wager from the account balance and notifies the game server. The game server then determines an outcome and any associated award for the play of the game. The game server notifies the payment server of any nonzero award, and the payment server increases the player's account balance by the nonzero award. The game server sends data representing the outcome and any award to the personal gaming device, which displays the outcome and any award.

In certain embodiments, the one or more servers enable web-based game play using a personal gaming device only if the personal gaming device satisfies one or more jurisdictional requirements. In one embodiment, the one or more servers enable web-based game play using the personal gaming device only if the personal gaming device is located within a designated geographic area (such as within certain state or county lines or within the boundaries of a gaming establishment). In this embodiment, the geolocation module of the personal gaming device determines the location of the personal gaming device and sends the location to the one or more servers, which determine whether the personal gaming device is located within the designated geographic area. In various embodiments, the one or more servers enable non-monetary wager-based game play if the personal gaming device is located outside of the designated geographic area.

In various embodiments, the system includes an EGM configured to communicate with a personal gaming device—such as a smartphone, a tablet computer, a desktop computer, or a laptop computer—to enable tethered mobile game play using the personal gaming device. Generally, in these embodiments, the EGM establishes communication with the personal gaming device and enables the player to play games on the EGM remotely via the personal gaming device. In certain embodiments, the system includes a geo-fence system that enables tethered game play within a particular geographic area but not outside of that geographic area.

In certain embodiments, the system is configured to communicate with a social network server that hosts or partially hosts a social networking website via a data network (such as the Internet) to integrate a player's gaming experience with the player's social networking account. This enables the system to send certain information to the social network server that the social network server can use to create content (such as text, an image, and/or a video) and post it to the player's wall, newsfeed, or similar area of the social networking website accessible by the player's connections (and in certain cases the public) such that the player's connections can view that information. This also enables the system to receive certain information from the social network server, such as the player's likes or dislikes or the player's list of connections. In certain embodiments, the system enables the player to link the player's player account to the player's social networking account(s). This enables the system to, once it identifies the player and initiates a gaming session (such as via the player logging in to a website (or an application) on the player's personal gaming device or via the player inserting the player's player tracking card into an EGM), link that gaming session to the player's social networking account(s). In other embodiments, the system enables the player to link the player's social networking account(s) to individual gaming sessions when desired by providing the required login information.

For instance, in one embodiment, if a player wins a particular award (e.g., a progressive award or a jackpot award) or an award that exceeds a certain threshold (e.g., an award exceeding $1,000), the system sends information about the award to the social network server to enable the server to create associated content (such as a screenshot of the outcome and associated award) and to post that content to the player's wall (or other suitable area) of the social networking website for the player's connections to see (and to entice them to play). In another embodiment, if a player joins a multiplayer game and there is another seat available, the system sends that information to the social network sever to enable the server to create associated content (such as text indicating a vacancy for that particular game) and to post that content to the player's wall (or other suitable area) of the social networking website for the player's connections to see (and to entice them to fill the vacancy). In another embodiment, if the player consents, the system sends advertisement information or offer information to the social network server to enable the social network server to create associated content (such as text or an image reflecting an advertisement and/or an offer) and to post that content to the player's wall (or other suitable area) of the social networking website for the player's connections to see. In another embodiment, the system enables the player to recommend a game to the player's connections by posting a recommendation to the player's wall (or other suitable area) of the social networking website.

Certain of the systems described herein, such as EGMs located in a casino or another gaming establishment, include certain components and/or are configured to operate in certain manners that differentiate these systems from general purpose computing devices, i.e., certain personal gaming devices such as desktop computers and laptop computers.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general-purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general-purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general-purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general-purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general-purpose computing device.

A second difference between EGMs and general-purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulator in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general-purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general-purpose computing devices is that EGMs have unique peripheral device requirements that differ from those of a general-purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purposes computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general-purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third-party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general-purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor, cause the processor to:
maintain a progressive award associated with a first gaming device, and
responsive to an occurrence of a progressive award modification event:
modify a value of the progressive award, and
responsive to the modified value of the progressive award being associated with a progressive award reassociation event:
identify a second gaming device, and
modify any association between the progressive award and the identified second gaming device.

2. The system of claim 1, wherein the progressive award modification event comprises a progressive award increment event, modifying the value of the progressive award comprises increasing the value of the progressive award, and modifying any association between the progressive award and the identified second gaming device comprises associating the progressive award with the identified second gaming device.

3. The system of claim 2, wherein the second gaming device is identified based on the first gaming device.

4. The system of claim 2, wherein the modified value of the progressive award is associated with the progressive award reassociation event responsive to the increased value of the progressive award at least reaching an incremented threshold value.

5. The system of claim 1, wherein the progressive award modification event comprises a progressive award decrement event, and modifying the value of the progressive award comprises decreasing the value of the progressive award.

6. The system of claim 5, wherein modifying any association between the progressive award and the identified second gaming device comprises disassociating the progressive award from the identified second gaming device.

7. The system of claim 5, wherein the memory device stores a plurality of further instructions that, when executed by the processor responsive to the modified value of the progressive award being associated with the progressive award reassociation event, cause the processor to disassociate the progressive award from the first gaming device.

8. The system of claim 1, wherein the memory device stores a plurality of further instructions that, when executed by the processor responsive to the modified value of the progressive award being associated with the progressive award reassociation event, cause the processor to identify a quantity of at least two second gaming devices, and sequentially modify any association between the progressive award and each of the second gaming devices.

9. The system of claim 8, wherein the quantity of second gaming devices is determined based on the modified value of the progressive award.

10. A system comprising:
a processor; and
a memory device that stores a plurality of instructions that, when executed by the processor, cause the processor to:
maintain a progressive award, and
responsive to an occurrence of a progressive award increment event:
increase a value of the progressive award, and
responsive to the increased value of the progressive award at least reaching an incremented threshold value:
associate a gaming device with the progressive award, and
responsive to a subsequent occurrence of a progressive award reset event:
reset the value of the progressive award, and
disassociate the gaming device from the progressive award.

11. The system of claim 10, wherein different incremented threshold values are associated with associated different gaming devices with the progressive award.

12. A method of operating a system, the method comprising:
maintaining, by a processor, a progressive award associated with a first gaming device, and
responsive to an occurrence of a progressive award modification event:
modifying, by the processor, a value of the progressive award, and
responsive to the modified value of the progressive award being associated with a progressive award reassociation event:
identifying a second gaming device, and
modifying, by the processor, any association between the progressive award and the identified second gaming device.

13. The method of claim 12, wherein the progressive award modification event comprises a progressive award increment event, modifying the value of the progressive award comprises increasing the value of the progressive award, and modifying any association between the progressive award and the identified second gaming device comprises associating the progressive award with the identified second gaming device.

14. The method of claim 13, wherein the second gaming device is identified based on the first gaming device.

15. The method of claim 13, wherein the modified value of the progressive award is associated with the progressive award reassociation event responsive to the increased value of the progressive award at least reaching an incremented threshold value.

16. The method of claim 12, wherein the progressive award modification event comprises a progressive award decrement event, and modifying the value of the progressive award comprises decreasing the value of the progressive award.

17. The method of claim 16, wherein modifying any association between the progressive award and the identified second gaming device comprises disassociating the progressive award from the identified second gaming device.

18. The method of claim 16, further comprising, responsive to the modified value of the progressive award being associated with the progressive award reassociation event, disassociating, by the processor, the progressive award from the first gaming device.

19. The method of claim 12, further comprising, responsive to the modified value of the progressive award being associated with the progressive award reassociation event, identifying a quantity of at least two second gaming devices, and sequentially modifying, by the processor, any association between the progressive award and each of the second gaming devices.

20. The method of claim 19, wherein the quantity of second gaming devices is determined based on the modified value of the progressive award.
